(19) United States
(12) Patent Application Publication
(10) Pub. No.: US 2025/0063403 A1
(43) Pub. Date: Feb. 20, 2025

(54) METHOD FOR REPORTING SENSING RESULT, SENSING-BY-PROXY INITIATOR AND SENSING-BY-PROXY RESPONDER

(71) Applicant: GUANGDONG OPPO MOBILE TELECOMMUNICATIONS CORP., LTD., Dongguan (CN)

(72) Inventors: Chaoming LUO, Dongguan (CN); Lei HUANG, Singapore (SG)

(21) Appl. No.: 18/920,052

(22) Filed: Oct. 18, 2024

Related U.S. Application Data
(63) Continuation of application No. PCT/CN2022/089415, filed on Apr. 26, 2022.

(51) Int. Cl. H04W 24/08; H04W 84/12

(52) U.S. Cl. CPC H04W 24/08; H04W 84/12

(57) ABSTRACT

Provided is a method for reporting a sensing result. The method is applicable to a sensing-by-proxy initiator, and includes: transmitting a sensing-by-proxy report request frame to a sensing-by-proxy responder, wherein the sensing-by-proxy report request frame is for requesting the sensing-by-proxy responder to report the sensing result; and receiving a sensing-by-proxy report frame or a sensing-by-proxy report frame set from the sensing-by-proxy responder, wherein the sensing-by-proxy report frame or the sensing-by-proxy report frame set carries the sensing result.

### CROSS-REFERENCE TO RELATED APPLICATION

This application is a continuation of International Application No. PCT/CN2022/089415, filed Apr. 26, 2022, the entire disclosure of which is incorporated herein by reference.

### TECHNICAL FIELD

The present disclosure relates to the field of wireless communications, and in particular, relates to a method and apparatus for reporting a sensing result, and a device and a storage medium thereof.

### BACKGROUND

Wireless local area network (WLAN) sensing refers to a technology for sensing a person or an object in an environment by measuring changes in WLAN signals scattered and/or reflected by the person or the object.

### SUMMARY

Embodiments of the present disclosure provide a method and apparatus for reporting a sensing result, and a device and a storage medium thereof. The technical solutions are as follows.

According to some embodiments of the present disclosure, a method for reporting a sensing result applicable to a sensing-by-proxy initiator is provided. The method includes:
transmitting a sensing-by-proxy report request frame to a sensing-by-proxy responder, where the sensing-by-proxy report request frame is for requesting the sensing-by-proxy responder to report the sensing result; and
receiving a sensing-by-proxy report frame or a sensing-by-proxy report frame set from the sensing-by-proxy responder, where the sensing-by-proxy report frame or the sensing-by-proxy report frame set carries the sensing result.

According to some embodiments of the present disclosure, a method for reporting a sensing result applicable to a sensing-by-proxy responder is provided. The method includes:
receiving a sensing-by-proxy report request frame transmitted by a sensing-by-proxy initiator, where the sensing-by-proxy report request frame is for requesting the sensing-by-proxy responder to report the sensing result; and
transmitting a sensing-by-proxy report frame or a sensing-by-proxy report frame set to the sensing-by-proxy transmitter, where the sensing-by-proxy report frame or the sensing-by-proxy report frame set carries the sensing result.

According to some embodiments of the present disclosure, an apparatus for reporting a sensing result is provided. The apparatus includes:
a first transmitting module, configured to transmit a sensing-by-proxy report request frame to a sensing-by-proxy responder, where the sensing-by-proxy report request frame is for requesting the sensing-by-proxy responder to report the sensing result; and
a first receiving module, configured to receive a sensing-by-proxy report frame or a sensing-by-proxy report frame set from the sensing-by-proxy responder, where the sensing-by-proxy report frame or the sensing-by-proxy report frame set carries the sensing result.

According to some embodiments of the present disclosure, an apparatus for reporting a sensing result is provided. The apparatus includes:
a second receiving module, configured to receive a sensing-by-proxy report request frame transmitted by a sensing-by-proxy initiator, where the sensing-by-proxy report request frame is for requesting the sensing-by-proxy responder to report the sensing result; and
a second transmitting module, configured to transmit a sensing-by-proxy report frame or a sensing-by-proxy report frame set to the sensing-by-proxy transmitter, where the sensing-by-proxy report frame or the sensing-by-proxy report frame set carries the sensing result.

According to some embodiments of the present disclosure, a sensing-by-proxy initiator is provided. The sensing-by-proxy initiator includes: a processor and a transceiver connected to the processor, where
the transceiver is configured to transmit a sensing-by-proxy report request frame to a sensing-by-proxy responder, where the sensing-by-proxy report request frame is for requesting the sensing-by-proxy responder to report the sensing result; and
the transceiver is configured to receive a sensing-by-proxy report frame or a sensing-by-proxy report frame set from the sensing-by-proxy responder, where the sensing-by-proxy report frame or the sensing-by-proxy report frame set carries the sensing result.

According to some embodiments of the present disclosure, a sensing-by-proxy responder is provided. The sensing-by-proxy responder includes: a processor and a transceiver connected to the processor, where
the transceiver is configured to receive a sensing-by-proxy report request frame transmitted by a sensing-by-proxy initiator, where the sensing-by-proxy report request frame is for requesting the sensing-by-proxy responder to report the sensing result; and
the transceiver is configured to transmit a sensing-by-proxy report frame or a sensing-by-proxy report frame set to the sensing-by-proxy transmitter, where the sensing-by-proxy report frame or the sensing-by-proxy report frame set carries the sensing result.

According to some embodiments of the present disclosure, a sensing-by-proxy initiator is provided. The sensing-by-proxy initiator includes: a processor and a memory, where at least one program is stored in the memory, and the sensing-by-proxy initiator, when loading and running the at least one program, is caused to perform the method for reporting the sensing result as defined in the above embodiments.

According to some embodiments of the present disclosure, a sensing-by-proxy responder is provided. The sensing-by-proxy responder includes: a processor and a memory, where at least one program is stored in the memory, and the sensing-by-proxy responder, when loading and running the at least one program, is caused to perform the method for reporting the sensing result as defined in the above embodiments.

According to some embodiments of the present disclosure, a non-transitory computer-readable storage medium is provided, where at least one program is stored in the computer-readable storage medium, and the at least one program, when loaded and run by a computer device, causes the computer device to perform the method for reporting the sensing result as defined in the above embodiments.

According to some embodiments of the present disclosure, a chip is provided. The chip includes one or more programmable logic circuits and/or one or more program instructions, and a computer device provided with the chip is configured to implement the method for reporting the sensing result as defined in the above embodiments.

According to some embodiments of the present disclosure, a computer program product is provided. The computer program product, when running on (a processor of) a computer device, causes the computer device to perform the method for reporting the sensing result as defined in the above embodiments.

The technical solutions according to the embodiments of the present disclosure include at least the following beneficial effects.

A sensing-by-proxy initiator transmits a sensing-by-proxy report request frame to a sensing-by-proxy responder, and the sensing-by-proxy responder feeds back a sensing-by-proxy report frame or a sensing-by-proxy report frame set corresponding to the sensing-by-proxy report request frame. The sensing-by-proxy report frame or the sensing-by-proxy report frame set carries a sensing result of sensing measurement. The present disclosure provides a sensing result reporting scheme between the sensing-by-proxy initiator and the sensing-by-proxy responder based on paired “sensing-by-proxy report request frame and sensing-by-proxy report frame/set”. Even if a data volume of the sensing result is large, such as of dozens to hundreds of bytes, the sensing result is reported to the sensing-by-proxy initiator in batches based on a plurality of sets of frame sequences of “sensing-by-proxy report request frame and sensing-by-proxy report frame/set”.

### BRIEF DESCRIPTION OF THE DRAWINGS

For clearer descriptions of the technical solutions according to the embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a wireless communication system according to some exemplary embodiments of the present disclosure;

FIG. 2 is a schematic diagram of a sensing measurement process according to some exemplary embodiments of the present disclosure;

FIG. 3 is a schematic diagram of a sensing process for sensing measurement according to some exemplary embodiments of the present disclosure;

FIG. 4 is a schematic diagram of a sensing process for sensing measurement according to some exemplary embodiments of the present disclosure;

FIG. 5 is a flowchart of a method for sensing measurement according to some exemplary embodiments of the present disclosure;

FIG. 6 is a flowchart of a method for reporting a sensing result according to some exemplary embodiments of the present disclosure;

FIG. 7 is a flowchart of a method for reporting a sensing result according to some exemplary embodiments of the present disclosure;

FIG. 8 is a schematic diagram of a frame sequence based on a short interframe space (SIFS) interval according to some exemplary embodiments of the present disclosure;

FIG. 9 is a schematic diagram of a frame sequence of a retransmission mode one based on an SIFS interval according to some exemplary embodiments of the present disclosure;

FIG. 10 is a schematic diagram of a frame sequence of a retransmission mode two based on an SIFS interval according to some exemplary embodiments of the present disclosure;

FIG. 11 is a schematic diagram of a frame sequence based on an SIFS interval according to other exemplary embodiments of the present disclosure;

FIG. 12 is a schematic diagram of a frame sequence of a retransmission mode one based on an SIFS interval according to other exemplary embodiments of the present disclosure;

FIG. 13 is a schematic diagram of a frame sequence of a retransmission mode one based on an SIFS interval according to other exemplary embodiments of the present disclosure;

FIG. 14 is a schematic diagram of a frame sequence of a retransmission mode two based on an SIFS interval according to other exemplary embodiments of the present disclosure;

FIG. 15 is a flowchart of a method for reporting a sensing result according to some exemplary embodiments of the present disclosure;

FIG. 16 is a schematic diagram of a frame sequence based on a timeout duration T and a unidirectional Ack frame according to some exemplary embodiments of the present disclosure;

FIG. 17 is a schematic diagram of a frame sequence based on a timeout duration T and a bidirectional Ack frame according to some exemplary embodiments of the present disclosure;

FIG. 18 is a flowchart of a method for terminating sensing measurement according to some exemplary embodiments of the present disclosure;

FIG. 19 is a flowchart of a method for terminating sensing measurement according to some exemplary embodiments of the present disclosure;

FIG. 20 is a flowchart of a method for terminating sensing measurement according to some exemplary embodiments of the present disclosure;

FIG. 21 is a schematic diagram of a frame structure of a sensing-by-proxy request report frame according to some exemplary embodiments of the present disclosure;

FIG. 22 is a schematic diagram of a frame structure of a sensing-by-proxy request report frame according to some exemplary embodiments of the present disclosure;

FIG. 23 is a schematic diagram of a frame structure of a sensing-by-proxy request report frame according to some exemplary embodiments of the present disclosure;

FIG. 24 is a schematic diagram of a frame structure of a sensing-by-proxy request report frame according to some exemplary embodiments of the present disclosure;

FIG. 25 is a schematic diagram of a frame structure of a sensing-by-proxy request report frame according to some exemplary embodiments of the present disclosure;

FIG. 26 is a schematic diagram of a frame structure of a sensing-by-proxy request report frame according to some exemplary embodiments of the present disclosure;

FIG. 27 is a schematic diagram of a frame structure of a sensing-by-proxy report frame according to some exemplary embodiments of the present disclosure;

FIG. 28 is a schematic diagram of a frame structure of a sensing-by-proxy termination frame according to some exemplary embodiments of the present disclosure;

FIG. 29 is a schematic diagram of a frame structure of a sensing-by-proxy termination frame according to some exemplary embodiments of the present disclosure;

FIG. 30 is a structural block diagram of an apparatus for reporting a sensing result according to some exemplary embodiments of the present disclosure;

FIG. 31 is a structural block diagram of an apparatus for reporting a sensing result according to some exemplary embodiments of the present disclosure; and

FIG. 32 is a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

First, several terms involved in the present disclosure are briefly described hereinafter.

A physical protocol data unit (PPDU) refers to a protocol data unit in the case that data is packaged in a physical layer.

A medium access control (MAC) protocol data unit (MPDU) refers to a protocol data unit in the case that data is packaged in an MAC layer.

An aggregate MAC protocol data unit (A-MPDU) refers to a structure containing one or more MPDUs, and is transmitted by a physical layer as a physical layer (PHY) service data unit (PSDU) contained in a PPDU.

An MAC management protocol data unit (MMPDU) is included in an MPDU.

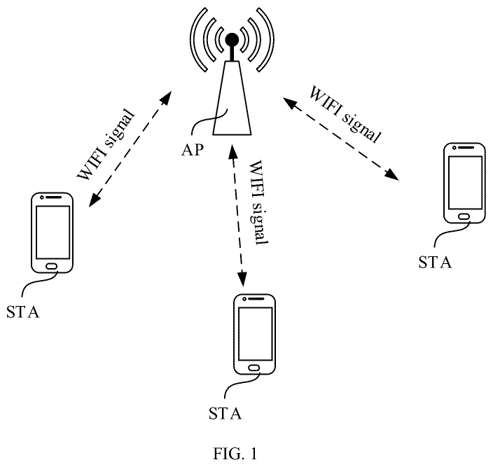

FIG. 1 shows a block diagram of a WLAN system according to some exemplary embodiments of the present disclosure. The WLAN system includes an access point (AP) and a station (STA).

In some scenarios, the AP is also referred to as an AP STA. That is, the AP is also the STA in some way. In some scenarios, the STA is also referred to as a non-AP STA.

In some embodiments, STAs include an AP STA and a non-AP STA.

The communication within the communication system involves communication between the AP and the non-AP STA, communication between non-AP STAs, or communication between the STA and a peer STA, The peer STA refers to a device communicating with the STA at a opposite terminal. For example, the peer STA is an AP or a non-AP STA.

The AP is a bridge to connect wired and wireless networks, and mainly functions as connecting various wireless network clients and then accessing the wireless network to the Ethernet. AP devices are terminal devices (such as mobile phones) equipped with wireless-fidelity (WiFi) chips or network devices (such as routers).

It should be understood that the role of the STA in the communication system is not absolute. For example, in some scenarios, the mobile phone is a non-AP STA in the case that a mobile phone connects to a router, and the mobile phone is an AP in the case that the mobile phone is a hotspot for other mobile phones.

Both the AP and the non-AP STA are devices applicable to the Internet of Vehicles, nodes and sensors in Internet of Things (IoT), smart cameras, smart remote controls, smart water meters and electricity meters in smart homes, sensors in smart cities, and the like.

In some embodiments, the non-AP STA supports the 802.11be format. In some embodiments, the non-AP STA also supports various current and future WLAN formats of the 802.11 family, such as 802.11ax format, an 802.11ac format, an 802.11n format, an 802.11g format, an 802.11b format, an 802.11a format, and the like.

In some embodiments, the AP is a device that supports the 802.11be format. In some embodiments, the AP is also a device that supports various current and future WLAN formats of the 802.11 family, such as an 802.11ax format, an 802.11ac format, an 802.11n format, an 802.11g format, an 802.11b format, an 802.11a format, and the like.

In the embodiments of the present disclosure, the STA is a device that supports WLAN/WiFi technology, such as a mobile phone, a pad, a computer, a virtual reality (VR) device, an augmented reality (AR) device, an industrial control wireless device, a set-top box, a self-driving wireless device, an in-vehicle communication device, a remote medical wireless device, a smart grid wireless device, a transportation safety wireless device, a smart city or smart home wireless device, a wireless communication chip/application specific integrated circuit (ASIC)/system on chip (SoC), and the like.

Frequency bands supported by the WLAN technology include but are not limited to low-frequency bands (2.4 GHz, 5 GHz, and 6 GHz) and high-frequency bands (45 GHz and 60 GHz).

One or more links are present between the STA and the AP.

In some embodiments, the STA and the AP support multi-frequency-band communications, for example, simultaneous communications at frequency bands of 2.4 GHz, 5 GHz, 6 GHz, 45 GHz, and 60 GHz, or simultaneous communications in different channels at a same frequency band (or different frequency bands), such that the communication throughput and/or reliability between devices are improved. Such devices are often referred to as multi-frequency-band devices, multi-link devices (MHLDs), multi-link entities, or multi-frequency-band entities. The MLD is an AP device or an STA device. In the case that the MLD is an AP device, the MLD includes one or more APs. In the case that the MLD is an STA device, the MLD includes one or more non-AP STAs.

The MLD including one or more APs is also referred to as an AP, and the MLD including one or more non-AP STAs is also referred to as a non-AP. In the embodiments of the present disclosure, the non-AP is also referred to as an STA.

In the embodiments of the present disclosure, the AP includes a plurality of APs, the non-AP includes a plurality of STAs, a plurality of links are formed between the APs in the AP and the STAs in the non-AP, and data communication between the APs in the AP and the corresponding STAs in the non-AP is achieved over the corresponding links.

The AP is a device deployed in a WLAN to provide a wireless communication function for the STA. The STA 0 includes: user equipment (UE), an access terminal, a subscriber unit, a subscriber station, a mobile station, a mobile console, a remote station, a remote terminal, a mobile device, a wireless communication device, a user agent, a user device, and the like. In some embodiments, the STA 10 is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, or a wearable device, which is not limited in the embodiments of the present disclosure.

In the embodiments of the present disclosure, the STA and the AP both support the IEEE 802.11 format.

In a WLAN sensing scenario, WLAN terminals involved in sensing include: a sensing session initiator and a sensing session responder. Alternatively, WLAN terminals involved in sensing include: a sensing signal transmitter and a sensing signal receiver. The sensing session initiator is a sensing initiator for short, and the sensing session responder is a sensing responder for short.

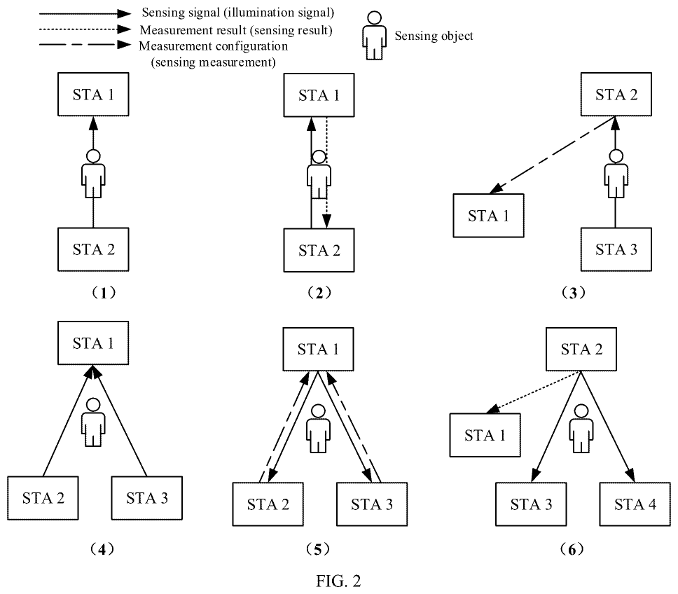

FIG. 2 (1) to (6) show six typical scenarios of WLAN sensing based on sensing signals according to some exemplary embodiments of the present disclosure.

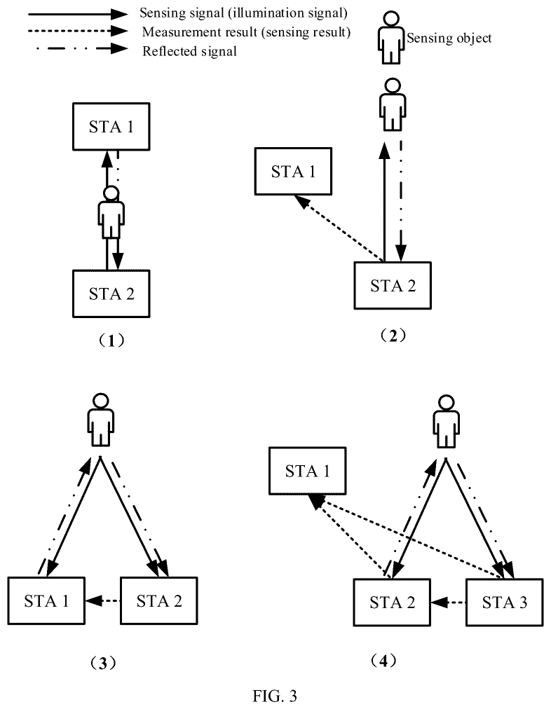

FIG. 3 (1) to (4) show four typical scenarios of WLAN sensing based on sensing signals and reflected signals according to some exemplary embodiments of the present disclosure.

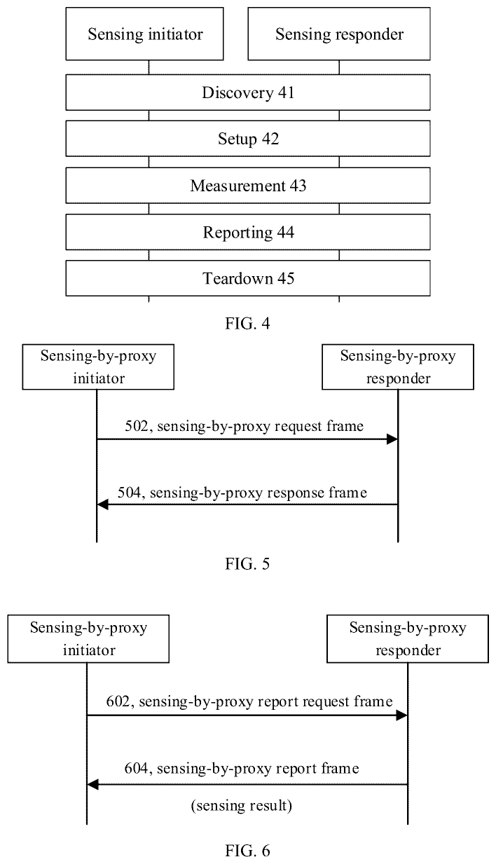

FIG. 4 shows a flow diagram of an exemplary sensing measurement. The WLAN sensing measurement includes one or more of the following phases: discovery 41, setup 42, measurement 43, reporting 44, and teardown 45.

The same terminal may play one or more roles in a sensing measurement. For example, the sensing initiator is only a sensing initiator, a sensing signal transmitter, a sensing signal receiver, or both a sensing signal transmitter and a sensing signal receiver.

The discovery phase 41 is used for initiating sensing measurement.

In the setup phase 42, the sensing measurement is set up, devices involved in the sensing measurement and roles thereof (including the sensing signal transmitting device and the sensing signal receiver) are determined, operation parameters related to the sensing measurement are determined, and the parameters are interchanged between terminals in some embodiments.

In the measurement phase 43, the sensing measurement is implemented, and a sensing signal is transmitted to the sensing signal receiver by the sensing signal transmitter.

In the reporting phase 44, a measurement result is reported as determined by the application scenario. For example, the sensing signal receiver needs to report the measurement result to the sensing measurement initiator.

In the teardown phase 45, the terminal stops the measurement and terminates the sensing measurement.

The above examples illustrate the WLAN sensing process provided in some practices. In some scenarios, it is desirable for a device B to provide proxy sensing measurement in the case that a device A needs to perform sensing measurement but is not suitable as a sensing initiator. That is, the device A acts as a sensing-by-proxy initiator and requests the device B to act as a sensing-by-proxy responder, and the device B acts as the above-mentioned sensing initiator in FIG. 4 in place of the device A to help the device A perform the sensing measurement. After performing the sensing measurement on behalf of device A, the device B reports a sensing result of the sensing measurement to the device A for subsequent use.

As the device B may perform a plurality of measurement instances with a plurality of devices C in the sensing measurement (one sensing measurement is one sensing measurement instance), each sensing measurement instance generates at least one measurement result. The sensing result of each sensing measurement thus includes one or more measurement results. Each measurement result may be split into a plurality of pieces of frame data. Therefore, how the device B reports the sensing result of the sensing measurement to the device A is an urgent technical problem to be solved.

FIG. 5 shows a flowchart of a method for sensing measurement according to some embodiments of the present disclosure. The method is applicable to a sensing-by-proxy initiator, and the method may include the following steps.

In S502, the sensing-by-proxy initiator transmits a sensing-by-proxy request frame to a sensing-by-proxy responder, where the sensing-by-proxy request frame is configured to request the sensing-by-proxy responder to perform the sensing measurement on behalf of the sensing-by-proxy initiator.

In some embodiments, the sensing-by-proxy initiator transmits the sensing-by-proxy request frame to the sensing-by-proxy responder, and the sensing-by-proxy responder initiates the sensing measurement upon receiving the sensing-by-proxy request frame. That is, the sensing-by-proxy initiator initiates the sensing measurement through the sensing-by-proxy responder.

In some embodiments, the sensing-by-proxy initiator needs to indicate sensing requirement information to the sensing-by-proxy responder, and the sensing-by-proxy responder generates corresponding sensing measurement setup information based on the sensing requirement information and finds a suitable sensing responder to set up the sensing measurement process. In some embodiments, information carried in the sensing-by-proxy request frame is the sensing requirement information.

In some embodiments, the sensing measurement is WLAN sensing.

In some embodiments, the sensing-by-proxy initiator is a smart phone, a wearable device, or another device with a poor sensing measurement function; and the sensing-by-proxy responder is a wireless router or another device with a better sensing measurement function.

In addition, the sensing-by-proxy initiator may also be a terminal device, such as a personal computer (PC), a tablet, a smart television, and an intelligent robot, which is not specifically limited in the embodiments of the present disclosure. The sensing-by-proxy responder may also be a micro base station, a mobile base station, a television, or another device, which is not specifically limited in the embodiments of the present disclosure.

In S504, the sensing-by-proxy initiator receives a sensing-by-proxy response frame transmitted by the sensing-by-proxy responder.

According to the present disclosure, the sensing-by-proxy responder performs the sensing measurement process on behalf of the sensing-by-proxy initiator after initiation of the request by the sensing-by-proxy initiator. After receiving the request from the sensing-by-proxy initiator, the sensing-by-proxy responder transmits the sensing-by-proxy response.

In summary, in the method according to the embodiments of the present disclosure, the sensing-by-proxy initiator transmits the sensing-by-proxy request frame to the sensing-by-proxy responder, such that the sensing-by-proxy responder initiates the sensing measurement based on the sensing-by-proxy request frame, and the sensing-by-proxy initiator does not need to initiate the sensing measurement itself, such that the requirement on device parameters of the sensing-by-proxy initiator is reduced, and the application range of the sensing measurement is expanded.

FIG. 6 shows a flowchart of a method for reporting a sensing result according to some exemplary embodiments of the present disclosure. The method is applicable to a sensing-by-proxy initiator, and the method includes the following steps.

In S602, the sensing-by-proxy initiator transmits a sensing-by-proxy report request frame to a sensing-by-proxy responder.

The sensing result of a sensing measurement includes at least one measurement result. Upon acquiring at least one measurement result, the sensing-by-proxy responder caches the measurement result, and waits for the sensing-by-proxy report request frame (SBP report request) initiated by the sensing-by-proxy initiator. The sensing-by-proxy report request frame is for requesting the sensing-by-proxy responder to report the sensing result.

The sensing-by-proxy initiator transmits a sensing-by-proxy report frame to the sensing-by-proxy responder. Correspondingly, the sensing-by-proxy responder receives the sensing-by-proxy report request frame transmitted by the sensing-by-proxy initiator.

In some embodiments, a transmission time of the sensing-by-proxy report request frame is later than a transmission time of the sensing-by-proxy request frame in the above embodiments.

In S604, the sensing-by-proxy responder transmits a sensing-by-proxy report frame to the sensing-by-proxy initiator.

The sensing-by-proxy responder transmits the sensing-by-proxy report frame (SBP report) corresponding to the sensing-by-proxy report request frame to the sensing-by-proxy initiator. Correspondingly, the sensing-by-proxy initiator receives the sensing-by-proxy report frame transmitted by the sensing-by-proxy responder. The sensing-by-proxy report frame carries all or partial data of the sensing result.

Illustratively, one sensing-by-proxy report frame carries one piece of frame data. The frame data that can be carried by each sensing-by-proxy report frame is restricted by an upper limit. As the sensing result includes at least one measurement result, the data volumes of measurement results are different. Each piece of frame data carries frame data in at least one of the following forms:
partial data of one measurement result;
full data of one measurement result;
at least two measurement results,

for example, full data of three measurement results, or full data of two measurement results and partial data of one measurement result; and
all measurement results of one sensing result.

That is, in the case that the data volume of a measurement result is small, a sensing-by-proxy report frame carries the measurement result; and in the case that the data volume of a measurement result is large, the measurement result is split into a plurality of pieces of frame data based on the frame data capacity. One sensing-by-proxy report frame carries one piece of frame data, and the measurement result is reported in batches by a plurality of sensing-by-proxy report frames.

In some embodiments, the sensing-by-proxy report frame request frame and the sensing-by-proxy report frame are in at least two sets in pairs. However, it is not excluded that a number of the sensing-by-proxy report request frames is less than a number of the sensing-by-proxy report frames in some embodiments.

In summary, in the method according to the embodiments, the sensing-by-proxy initiator transmits the sensing-by-proxy report request frame to the sensing-by-proxy responder, and the sensing-by-proxy responder feeds back the sensing-by-proxy report frame corresponding to the sensing-by-proxy report request frame. The sensing-by-proxy report frame carries the sensing result of the sensing measurement. The present disclosure provides a sensing result reporting scheme between the sensing-by-proxy initiator and the sensing-by-proxy responder based on paired “sensing-by-proxy report request frame and sensing-by-proxy report frame”. Even if the data volume of the sensing result is large, such as of dozens to hundreds of bytes, the sensing result is reported to the sensing-by-proxy initiator in batches based on a plurality of sets of frame sequences of “sensing-by-proxy report request frame and sensing-by-proxy report frame”.

It should be noted that the above steps performed by the sensing-by-proxy initiator may be implemented separately as method embodiments applicable to the sensing-by-proxy initiator, and the above steps performed by the sensing-by-proxy responder may be implemented separately as method embodiments applicable to the sensing-by-proxy responder, which are not repeated hereinafter.

As described above, in the sensing measurement process set up by the sensing-by-proxy responder, a plurality of sensing signal receiver involve in the measurement. As each sensing signal receiver generates one measurement result, each sensing measurement instance generates a plurality of measurement results, and the sensing-by-proxy responder needs to report the generated plurality of measurement results to the sensing-by-proxy initiator. A size of a single measurement result may be hundreds of bytes to tens of thousands of bytes, such that all measurement results may not be carried in one sensing-by-proxy report frame, and the sensing-by-proxy initiator needs to request for the measurement results cached by the sensing-by-proxy responder one by one.

Illustratively, one PPDU includes one or more A-MPDUs, and one A-MPDU includes one or more MMPDUs. A measurement result generated by each sensing signal receiver in a measurement instance is split into a plurality of MMPDUs, and the plurality of MMPDUs are included in a same A-MPDU and further included in a same PPDU for transmission. Alternatively, the plurality of MMPDUs are included in different A-MPDUs and further included in different PPDUs for transmission. A plurality of measurement results (possibly generated by different sensing signal receivers, and possibly generated in a plurality of measurement instances) are included in one A-MPDU and further included in a same PPDU for transmission. A plurality of measurement results (possibly generated by different sensing signal receivers, and possibly generated in a plurality of measurement instances) are included in a plurality of A-MPDUs and further included in a same PPDU for transmission. That is, one sensing-by-proxy report frame carries one piece of frame data, each piece of frame data is one MMPDU, and each piece of frame data includes partial data of one measurement result in the sensing result, or all data of one measurement result, or data of at least two measurement results. One sensing result corresponds to one or more PPDUs.

Illustratively, one PPDU includes one or more A-MPDUs. One A-MPDU includes one or more MPDUs. One MPDU includes one MMPDU.

Illustratively, in the case that the data volume of the measurement result is large, the measurement result 1 is transmitted by using one to n MMPDUs. One to m MMPDUs belong to an A-MPDU 1, and m+1 to n MMPDUs belong to an A-MPDU 2.

Illustratively, in the case that the data volume of the measurement results is large, the measurement result 1 is transmitted by using one to n MMPDUs. The one to n MMPDUs belong to an A-MPDU 1.

Illustratively, in the case that the data volume of the measurement results is large, the measurement result 1 is transmitted by using one to m MMPDUs. The one to m MMPDUs belong to an A-MPDU 1. The measurement result 2 is transmitted by using m+1 to n MMPDUs. The m+1 to n MMPDUs belong to an A-MPDU 1.

Illustratively, in the case that the data volume of the measurement results is medium, the measurement result 1 is transmitted by using an MMPDU 1. The MMPDU 1 belongs to an A-MPDU 1. The measurement result 2 is transmitted by using an MMPDU 2. The MMPDU 2 belongs to an A-MPDU 1. The measurement result 3 is transmitted by using an MMPDU 3. The MMPDU 3 belongs to an A-MPDU 1.

Illustratively, in the case that the data volume of the measurement results is small, one to m measurement results are transmitted by using an MMPDU 1. The MMPDU 1 belongs to an A-MPDU 1. The m+1 to n measurement results are transmitted by using an MMPDU 2. The MMPDU 2 belongs to an A-MPDU 1.

In some embodiments, the sensing-by-proxy initiator requests the sensing-by-proxy responder to report the measurement result of the latest sensing measurement instance upon each sensing measurement instance. The sensing-by-proxy initiator further indicates a requested frequency of requesting the sensing-by-proxy responder to report the sensing result. The following describes specifically.

In option 1, the sensing-by-proxy initiator indicates, in the sensing-by-proxy request frame, the requested frequency of requesting the sensing-by-proxy responder to report the sensing result.

The sensing-by-proxy initiator transmits the sensing-by-proxy request frame to the sensing-by-proxy responder. The sensing-by-proxy request frame carries the requested frequency of the sensing result.

In option 2, the sensing-by-proxy initiator indicates, in a first sensing-by-proxy report request frame, the requested frequency of requesting the sensing-by-proxy responder to report the sensing result.

For example, the first sensing-by-proxy report request frame carries the requested frequency of the sensing result.

In option 3, the sensing-by-proxy initiator indicates, in each sensing-by-proxy report request frame, a transmission time of a next sensing-by-proxy report request frame, for example, transmitting upon several sensing measurement instances.

For example, an (i−1)th sensing-by-proxy report request frame carries a transmission time of an i^{th} sensing-by-proxy report request frame.

Each sensing-by-proxy report request frame has a sensing-by-proxy report frame or a sensing-by-proxy report frame set for feeding back the sensing-by-proxy report request frame. The i^{th} sensing-by-proxy report request frame and an i^{th} sensing-by-proxy report frame/set are regarded as a set, and the above- “sensing-by-proxy report request frame and the sensing-by-proxy report frame/set” are one or more sets in pairs, such that a frame sequence is formed. The sequence formed by the above “sensing-by-proxy report request frame and sensing-by-proxy report frame/set” includes at least two forms based on a difference of a frame interval time.

In sequence form 1, the inter-frame interval is a sequence of SIFS intervals.

An interval between the sensing-by-proxy report request frame and the sensing-by-proxy report frame/set adjacent to each other is one SIFS.

In sequence form 2, the inter-frame interval is not greater than a sequence of a predefined timeout time T.

An interval between the sensing-by-proxy report request frame and the sensing-by-proxy report frame/set adjacent to each other is not greater than the predefined timeout time T. The timeout time T is usually much longer than one SIFS.

The following embodiments are provided for the sequence form 1 (the SIFS interval).

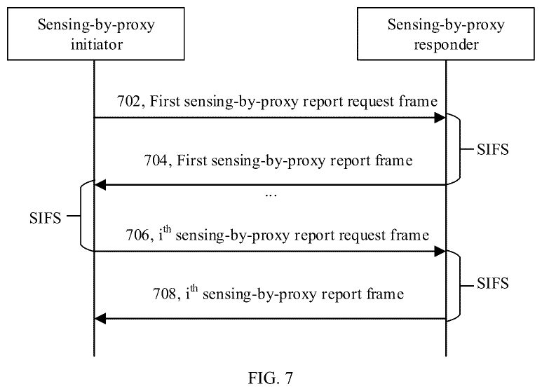

FIG. 7 is a flowchart of a method for reporting a sensing result according to some exemplary embodiments of the present disclosure. The embodiments are exemplified with the method being applicable to a sensing-by-proxy initiator and a sensing-by-proxy responder. The method includes the following steps.

In S702, the sensing-by-proxy initiator transmits a first sensing-by-proxy report request frame to the sensing-by-proxy responder in response to successful contention for a transmission opportunity.

The sensing-by-proxy initiator has successfully contended for a transmission opportunity in a wireless channel based on a channel backoff access process. The channel backoff access process includes at least a distributed coordination function (DCF) or an enhanced distributed channel access (EDCA) backoff, and the DCF and the EDCA are described in detail hereinafter.

Carrier sense multiple access with collision avoidance (CSMA/CA) is a core mechanism of the DCF and the EDCA. As the wireless channel has only the characteristics of a collision field, it is necessary to provide a random access mechanism to avoid the conflict caused by simultaneous access of the wireless channel by a plurality of devices. In the WiFi protocol, the random access mechanism is the CSMA/CA.

Upon successful contention for the transmission opportunity in the wireless channel, the sensing-by-proxy initiator transmits the first sensing-by-proxy report request frame to the sensing-by-proxy responder. Correspondingly, the sensing-by-proxy responder receives the first sensing-by-proxy report request frame.

In S704, the sensing-by-proxy responder transmits a first sensing-by-proxy report frame to the sensing-by-proxy initiator upon elapse of a SIFS from a reception end time of the first sensing-by-proxy report request frame.

Correspondingly, the sensing-by-proxy initiator receives the first sensing-by-proxy report frame.

The sensing-by-proxy responder caches cache data of the sensing result. The sensing result includes at least one measurement result. Due to the limited data capacity that can be carried by a same sensing-by-proxy report frame, depending on the data volume of the sensing result or the measurement result, the frame data carried by a sensing-by-proxy report frame carries: all data of one measurement result, or partial data of one measurement result, or at least two measurement results, or the entire sensing result.

In some embodiments, each sensing-by-proxy report frame is further indicative of an “index” of the carried frame data. The index is indicative of an index of the frame data in the cache of the sensing-by-proxy responder. For example, the sensing-by-proxy responder caches three pieces of frame data, and the indexes of the three pieces of frame data are 0, 1, and 2, separately. The index is also considered as the frame index of the sensing-by-proxy report frame.

In some embodiments, each sensing-by-proxy report frame further indicates whether the sensing-by-proxy responder has untransmitted cache frame data. In some embodiments, the sensing-by-proxy report frame carries a cache-or-not field. In the case that a value of the cache-or-not field is a first value, the sensing-by-proxy responder has untransmitted cache frame data. In the case that a value of the cache-or-not field is a second value, the sensing-by-proxy responder has no untransmitted cache frame data, that is, all the measurement results have been transmitted. For example, the first value is 1, yes, or true, and the second value is 0, no, or false.

In S706, the sensing-by-proxy initiator transmits an i^{th} sensing-by-proxy report request frame to the sensing-by-proxy responder upon elapse of the SIFS from a reception end time of an (i−1)^{th} sensing-by-proxy report frame.

i is an integer greater than 1. Correspondingly, the sensing-by-proxy responder receives the i^{th} sensing-by-proxy report request frame.

Illustratively, in the case that the (i−1)^{th} sensing-by-proxy report frame indicates that the sensing-by-proxy responder has untransmitted cache data, the sensing-by-proxy initiator transmits the i^{th} sensing-by-proxy report request frame to the sensing-by-proxy responder upon elapse of the SIFS from the reception end time of the (i−1)^{th} sensing-by-proxy report frame.

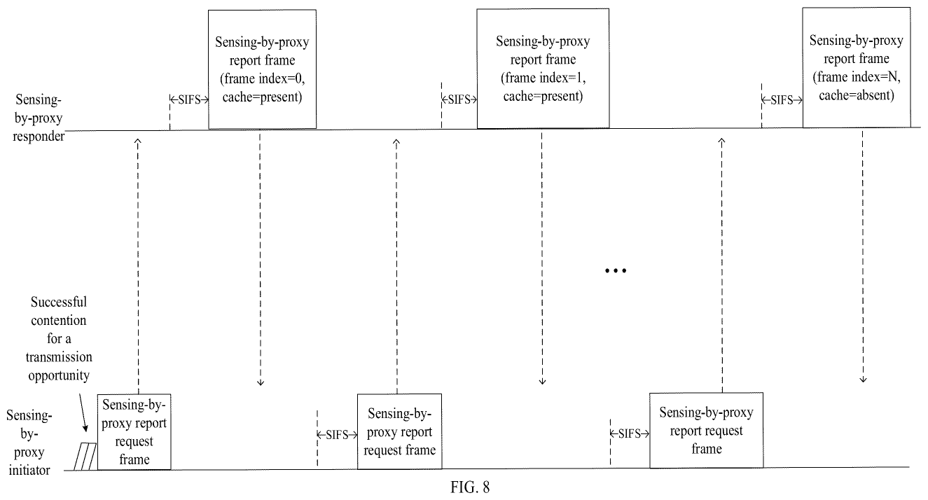

As shown in FIG. 8, the sensing-by-proxy report frame carries the cache-or-not field “more”. In the case that a value of the cache-or-not field “more” is the first value “true”, the first value “true” indicates that the sensing-by-proxy responder has untransmitted cache data. In this case, the sensing-by-proxy initiator transmits the i^{th} sensing-by-proxy report request frame to the sensing-by-proxy responder upon elapse of the SIFS from the reception end time of the (i−1)^{th} sensing-by-proxy report frame.

In S708, the sensing-by-proxy responder transmits an i^{th} sensing-by-proxy report frame to the sensing-by-proxy initiator upon elapse of the SIFS from a reception end time of the i^{th} sensing-by-proxy report request frame.

An interval between the sensing-by-proxy report request frame and the sensing-by-proxy report frame adjacent to each other is the SIFS. That is, an interval between the (i−1)^{th} sensing-by-proxy report frame and the i^{th} sensing-by-proxy report request frame is the SIFS. A time interval between the i^{th} sensing-by-proxy report request frame and the i^{th} sensing-by-proxy report frame is the SIFS.

As can be seen from FIG. 8, in the case that the sensing result is split into a plurality of pieces of frame data, the sensing-by-proxy initiator requests for the frame data cached by the sensing-by-proxy responder one by one. Illustratively, the frame data of each request is successfully received by the sensing-by-proxy initiator. In this process, the sensing-by-proxy initiator transmits a first sensing-by-proxy report request frame to the sensing-by-proxy responder upon successful contention for the transmission opportunity, the sensing-by-proxy responder starts to transmit the first sensing-by-proxy report frame within the SIFS time upon receiving the first proxy report request, and the sensing-by-proxy initiator continues to transmit the sensing-by-proxy report request frame within the SIFS time upon receiving the sensing-by-proxy report frame, until all data cached by the sensing-by-proxy responder has been received.

In some embodiments, the sensing-by-proxy report request frame is a newly defined control frame or an Action No Ack frame.

In some embodiments, the sensing-by-proxy report frame is an Action No Ack frame. The sensing-by-proxy report frame (SBP report) adopts a same frame format as a measurement result report frame (measurement report). The measurement result report frame is a frame transmitted to the sensing initiator by the sensing signal receiver and for reporting the measurement result.

As the sensing-by-proxy report frame needs to be transmitted at a specific time (the SIFS time upon receiving the sensing-by-proxy report request frame), no matter whether the sensing-by-proxy report frame adopts a same frame format as the measurement result report frame, the protected sensing-by-proxy report frame (protected SBP report) needs to use a different replay counter from other protected management frames in the case that a management frame protection function is enabled. In some embodiments, the protected sensing-by-proxy report frame uses a same newly added replay counter as the protected measurement result report frame. For applying the new replay counter, the protected sensing-by-proxy report frame and the protected measurement result report frame both belong to a protected sensing action frame category, instead of a protected dual of public action frame category.

In summary, according to the method according to the embodiments, upon acquiring the transmission opportunity through the sensing-by-proxy initiator, a frame sequence of “sensing-by-proxy report request frame and sensing-by-proxy report frame” is formed between the sensing-by-proxy initiator and the sensing-by-proxy responder based on the SIFS interval. As the interval between adjacent frames is a short SIFS, the reporting process of the entire sensing result is completed quickly, such that the speed of acquiring the complete sensing result by the sensing-by-proxy initiator is improved.

In the above reporting process of the sensing result, a sensing-by-proxy report frame may be not successfully received. In some embodiments, a retransmission mechanism is further provided.

### Retransmission Mechanism One (Immediate Retransmission)

It is assumed that the frame data in the (i−1)^{th} sensing-by-proxy report frame fails to be received. In the case that the (i−1)^{th} sensing-by-proxy report frame fails to be received, the i^{th} sensing-by-proxy report request frame is indicative of retransmission of the frame data in the (i−1)^{th} sensing-by-proxy report frame.

In some embodiments, the i^{th} sensing-by-proxy report request frame carries a retransmit-or-not field “retry”. In the case that a value of the retransmit-or-not field is a first value, the frame data failed in the current transmission is indicated to be retransmitted. In the case that a value of the retransmit-or-not field is a second value, a next piece of frame data is indicated to be initially transmitted. For example, the first value is 1, yes, or true, and the second value is 0, no, or false.

In some embodiments, in the case that a value of the retransmit-or-not field is the first value, the i^{th} sensing-by-proxy report request frame further carries an index of the frame data that needs to be retransmitted. In the case that an index of the frame data in the (i−1)^{th} sensing-by-proxy report frame is x, the i^{th} sensing-by-proxy report request frame further carries the index x of the frame data to allow the sensing-by-proxy responder to know the frame data to be retransmitted. In some embodiments, the index of the frame data is an optional field, and the frame data failed in the current transmission is implicitly indicated to be retransmitted in the case that the index of the frame data is not carried and a value of the retransmit-or-not field is the first value.

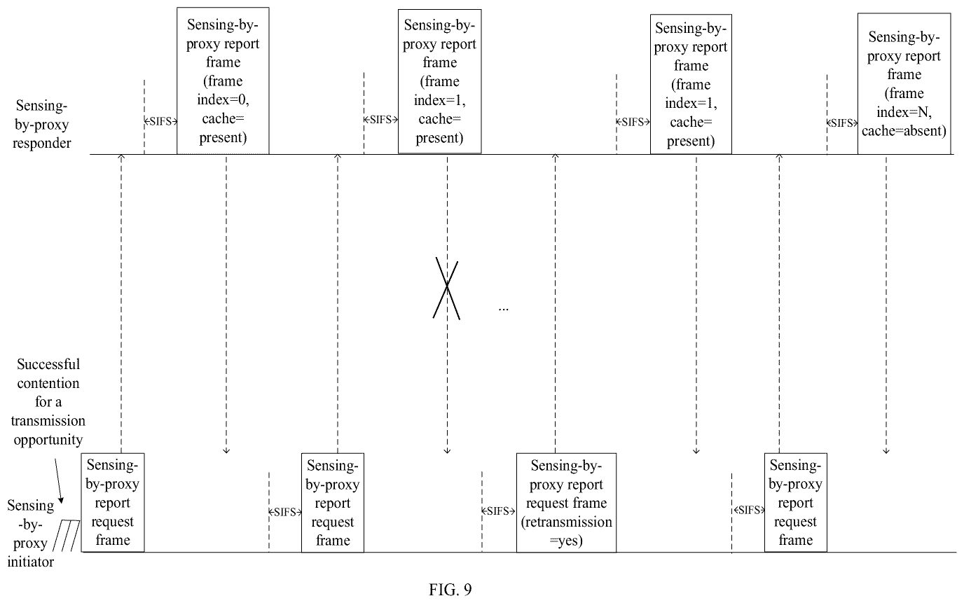

Referring to FIG. 9 illustratively, the frame data with an index 1 is not successfully received by the sensing-by-proxy initiator, and the sensing-by-proxy initiator retransmits a request to indicate the sensing-by-proxy responder to retransmit the frame data that is just transmitted (that is, the frame data with the index 1) in the case that a value of the retransmit-or-not field “retry” is equal to the first value “true”.

### Retransmission Mechanism Two (Retransmission Upon Transmission of the Last Piece of Frame Data)

In the case that the (i−1)^{th} sensing-by-proxy report frame indicates that the sensing result has no untransmitted cache frame data and a j^{th} sensing-by-proxy report frame fails to be received, the i^{th} sensing-by-proxy report request frame is transmitted to the sensing-by-proxy responder upon elapse of the SIFS from the reception end time of the (i−1)^{th} sensing-by-proxy report frame. The i^{th} sensing-by-proxy report request frame is indicative of retransmission of frame data in the j^{th} sensing-by-proxy report frame.

In the case that the cache-or-not field “more” of the (i−1)^{th} sensing-by-proxy report frame is equal to the second value “false”, the last piece of frame data has been transmitted. In the case that the j^{th} sensing-by-proxy report frame fails to be received in the whole reporting process, the i^{th} sensing-by-proxy report request frame is retransmitted to indicate retransmission of the frame data in the j^{th} sensing-by-proxy report frame. The frame data is partial data in the sensing result, and j is a positive integer not greater than i−1.

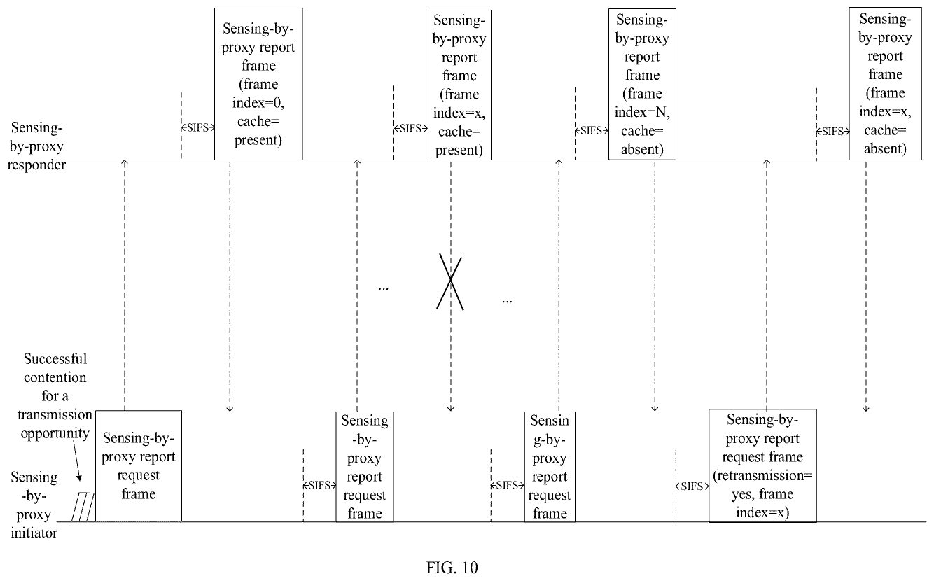

Referring to FIG. 10 illustratively, the frame data with an index x is not successfully received by the sensing-by-proxy initiator in the first report, and the sensing-by-proxy initiator continues to request subsequent frame data, until the sensing-by-proxy responder reports all cached frame data. The sensing-by-proxy initiator then transmits sensing-by-proxy report request frames for indicating retransmission one by one. The sensing-by-proxy report request frame instructs the sensing-by-proxy responder to retransmit various pieces of frame data that are not successfully received, such as the frame data with the index of x.

In some embodiments, in the case that the sensing-by-proxy initiator continuously fails to receive the frame data, for example, never receives the sensing-by-proxy report frame with the cache-or-not field “more” being equal to the second value “false”, a network error occurs, and the proxy sensing measurement process is terminated voluntarily.

Compared with the retransmission mechanism two, the frame data which is not successfully received in the retransmission mechanism one is retransmitted in time, thereby facilitating the sensing-by-proxy initiator to receive various pieces of frame data in sequence. The local cache of the sensing-by-proxy initiator supports the completion of splicing tasks of different pieces of frame data in receiving the frame data.

The frame sequence shown in FIG. 8 is exemplified with the sensing-by-proxy report frame transmitted each time as one frame. The frame sequence shown in FIG. 8 is at least applicable to the following two cases.

In case 1, one PPDU includes one non-A-MPDU, each non-A-MPDU includes one MMPDU, and one sensing-by-proxy report frame carries one MMPDU.

In case 2, one PPDU includes one A-MPDU, each A-MPDU includes one MMPDU, and one sensing-by-proxy report frame carries one MMPDU.

In some embodiments, the sensing-by-proxy responder transmits at least two sensing-by-proxy report frames to the sensing-by-proxy initiator each time, for example, one sensing-by-proxy report frame set.

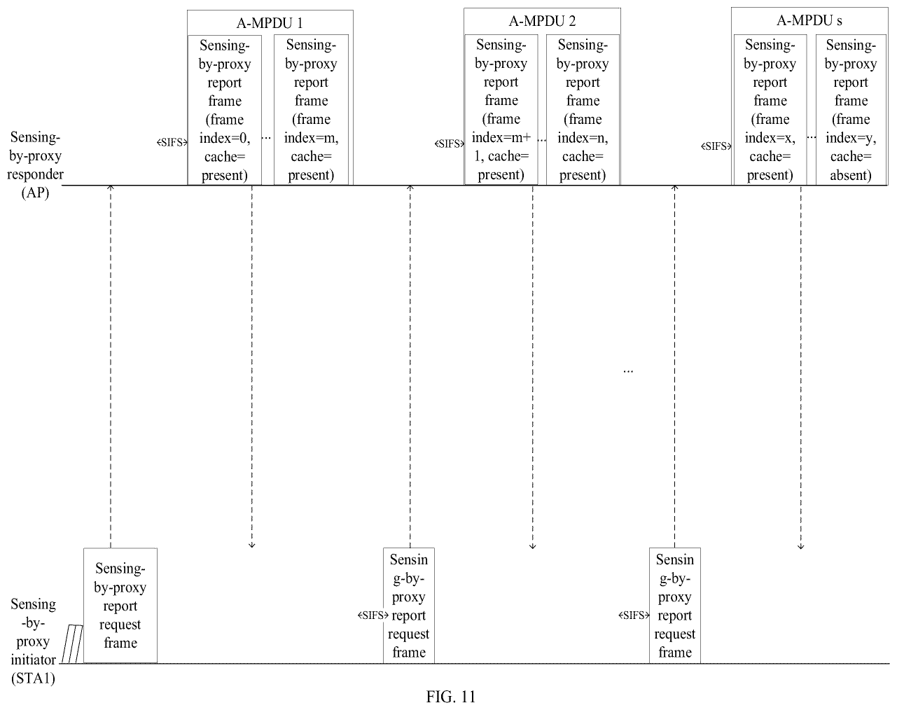

As shown in FIG. 11, upon successful contention for the transmission opportunity, the sensing-by-proxy initiator transmits the first sensing-by-proxy request report frame to the sensing-by-proxy responder. The sensing-by-proxy responder transmits a first sensing-by-proxy report frame set to the sensing-by-proxy initiator upon elapse of the SIFS from a reception end time of the first sensing-by-proxy request report frame. The first sensing-by-proxy report frame set includes m continuously transmitted sensing-by-proxy report frames (with indexes of 1 to m), each sensing-by-proxy report frame carries one MMPDU, and the m MMPDUs all belong to an A-MPDU 1. The sensing-by-proxy initiator transmits a second sensing-by-proxy report request frame to the sensing-by-proxy responder upon elapse of the SIFS from a reception end time of the first sensing-by-proxy report frame set. upon elapse of the SIFS from a reception end time of the second sensing-by-proxy request report frame, a second sensing-by-proxy report frame set includes n-m continuously transmitted sensing-by-proxy report frames (with indexes of m+1 to n), each sensing-by-proxy report frame carries one MMPDU, and the n-m MMPDUs all belong to an A-MPDU 2. The sensing-by-proxy initiator transmits a third sensing-by-proxy report frame set to the sensing-by-proxy responder upon elapse of the SIFS from a reception end time of the second sensing-by-proxy report frame set, and so on, until all data is transmitted.

A same sensing-by-proxy report frame set includes at least two sensing-by-proxy report frames, and the frame data of the at least two sensing-by-proxy report frames belong to a same A-MPDU. Illustratively, the frame sequence shown in FIG. 11 above is at least applicable to the following cases.

In case 3, one PPDU includes one A-MPDU, and the A-MPDU includes one or more MMPDUs. One sensing-by-proxy report frame carries one MMPDU.

In some embodiments, the above retransmission mechanism is exemplified with one piece of frame data as a retransmission unit. However, in some embodiments, in the case that transmission of one piece of frame data fails, the retransmission unit requested by the sensing-by-proxy initiator is one measurement result or one sensing result. That is, in the case that partial data of a measurement result fails to be received, retransmission of the entire measurement result is requested; and in the case that partial data of a sensing result fails to be received, retransmission of the entire sensing result is requested. The data volume requested for retransmission may be greater than the data volume carried by the frame data.

In some embodiments, in the case that the (i−1)^{th} sensing-by-proxy report frame fails to be received, the i^{th} sensing-by-proxy report request frame is indicative of retransmission of a measurement result or a sensing result corresponding to the (i−1)^{th} sensing-by-proxy report frame. In this case, the retransmission data is all data of the measurement result to which the frame data carried by the (i−1)^{th} sensing-by-proxy report frame belongs, or all data of the sensing result to which the frame data carried by the (i−1)^{th} sensing-by-proxy report frame belongs.

For example, partial data of the measurement result x is carried in the (i−1)^{th} sensing-by-proxy report frame, and the i^{th} sensing-by-proxy report request frame is indicative of retransmission of the entire measurement result x in the case that the (i−1)^{th} sensing-by-proxy report frame fails to be received. For example, partial data of the sensing result y is carried in the (i−1)^{th} sensing-by-proxy report frame, and the i^{th} sensing-by-proxy report request frame is indicative of retransmission of the entire sensing result y in the case that the (i−1)^{th} sensing-by-proxy report frame fails to be received.

In some embodiments, in the case that a j^{th} sensing-by-proxy report frame fails to be received, the i^{th} sensing-by-proxy report request frame is indicative of retransmission of a measurement result or a sensing result corresponding to the j^{th} sensing-by-proxy report frame. In this case, the retransmission data is all data of the measurement result to which the frame data carried by the j^{th} sensing-by-proxy report frame belongs, or all data of the sensing result to which the frame data carried by the j^{th} sensing-by-proxy report frame belongs.

For example, partial data of the measurement result x is carried in the j^{th} sensing-by-proxy report frame, and the i^{th} sensing-by-proxy report request frame is indicative of retransmission of the entire measurement result x in the case that the j^{th} sensing-by-proxy report frame fails to be received. For example, partial data of the sensing result y is carried in the j^{th} sensing-by-proxy report frame, and the i^{th} sensing-by-proxy report request frame is indicative of retransmission of the entire sensing result y in the case that the reception of the j^{th} sensing-by-proxy report frame fails to be received.

In some embodiments, the sensing-by-proxy responder transmits at least two sensing-by-proxy report frames to the sensing-by-proxy initiator each time, for example, one sensing-by-proxy report frame set. The retransmission unit may be the entire sensing-by-proxy report frame set, that is, all sensing-by-proxy report frames in the entire sensing-by-proxy report frame set, or a portion of the sensing-by-proxy report frames in the entire sensing-by-proxy report frame set.

In some embodiments, in the case that the (i−1)^{th} sensing-by-proxy report frame fails to be received, the i^{th} sensing-by-proxy report request frame is indicative of retransmission of all sensing-by-proxy report frames in the (i−1)^{th} sensing-by-proxy report frame set. In some embodiments, in the case that the frame index in the i^{th} sensing-by-proxy report request frame is null or the frame index includes indexes of all sensing-by-proxy report frames in the (i−1)^{th} sensing-by-proxy report frame set, the i^{th} sensing-by-proxy report request frame is indicative of retransmission of all sensing-by-proxy report frames in the (i−1)^{th} sensing-by-proxy report frame set.

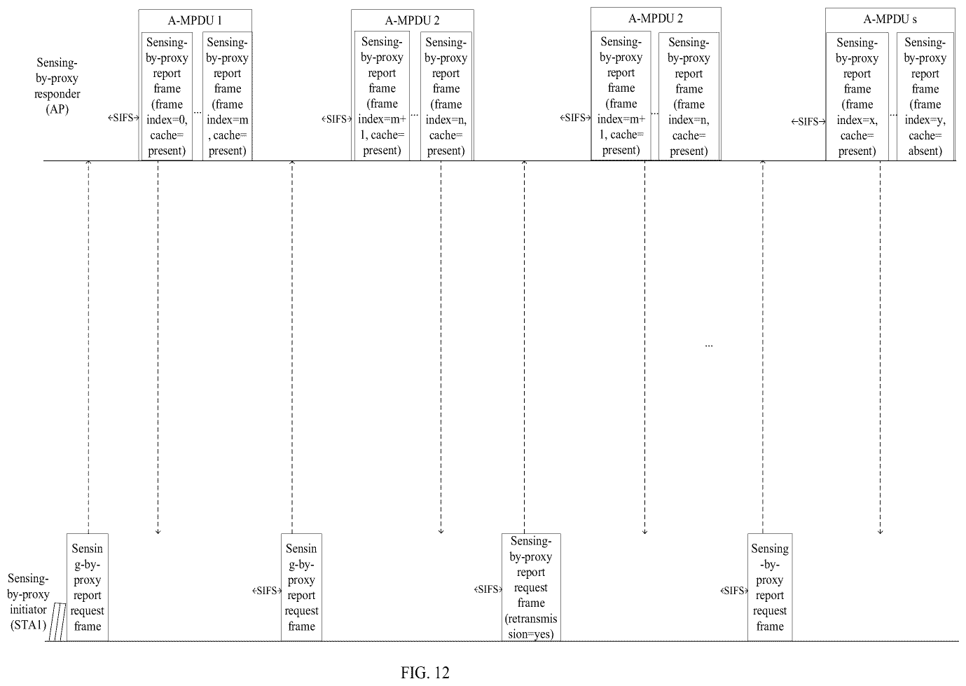

As shown in FIG. 12 illustratively, in the case that the second sensing-by-proxy report frame set fails to be received, a value of a retransmit-or-not field “retry” in a third sensing-by-proxy report request frame is equal to the first value “true” and does not indicate a frame index that needs to be retransmitted. In this case, the third sensing-by-proxy report request frame is indicative of retransmission of all sensing-by-proxy report frames in the second sensing-by-proxy report frame set.

In some embodiments, in the case that the (i−1)^{th} sensing-by-proxy report frame fails to be received, the i^{th} sensing-by-proxy report request frame is indicative of retransmission of a specified portion of the sensing-by-proxy report frames in the (i−1)^{th} sensing-by-proxy report frame set. In some embodiments, in the case that the frame index in the i^{th} sensing-by-proxy report request frame includes indexes of a portion of the sensing-by-proxy report frames in the (i−1)^{th} sensing-by-proxy report frame set, the i^{th} sensing-by-proxy report request frame is indicative of retransmission of the portion of the sensing-by-proxy report frames specified by the frame index in the (i−1)^{th} sensing-by-proxy report frame set.

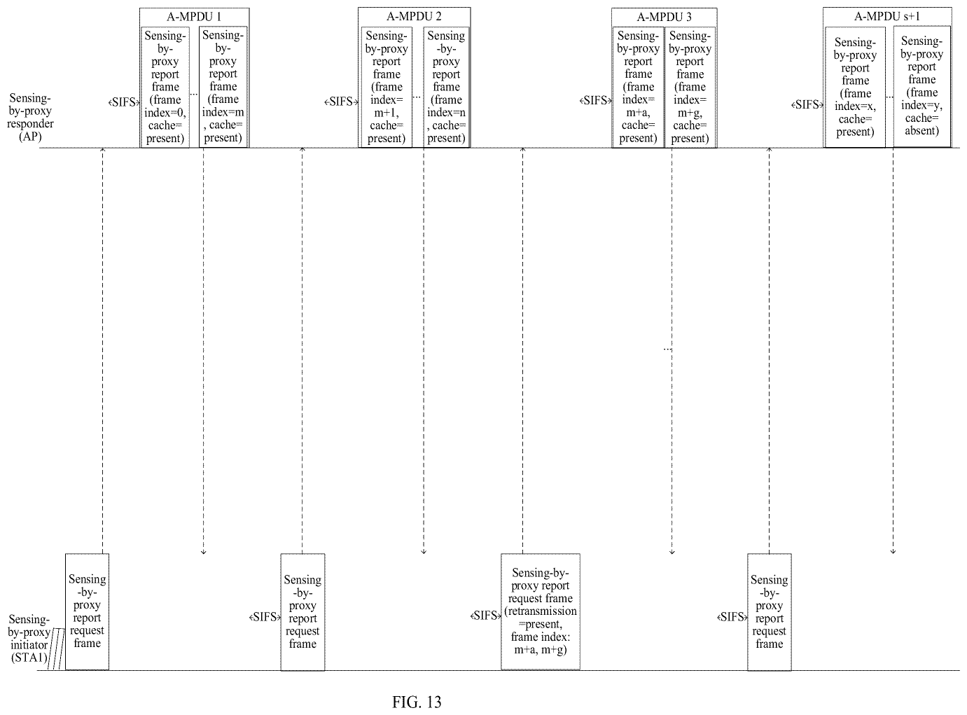

As shown in FIG. 13 illustratively, in the case that the second sensing-by-proxy report frame set fails to be received, a value of a retransmit-or-not field “retry” in a third sensing-by-proxy report request frame is equal to the first value “true” and indicates a frame index “m+a, m+g” that needs to be retransmitted. In this case, the third sensing-by-proxy report request frame is indicative of retransmission of an (m+a)^{th} sensing-by-proxy report frame and an (m+g)^{th} sensing-by-proxy report frame in the second sensing-by-proxy report frame set.

In some embodiments, in the case that the j^{th} sensing-by-proxy report frame fails to be received, the i^{th} sensing-by-proxy report request frame is indicative of retransmission of a specified portion of the sensing-by-proxy report frames in the j^{th} sensing-by-proxy report frame set. In some embodiments, in the case that the frame index in the i^{th} sensing-by-proxy report request frame includes indexes of a portion of the sensing-by-proxy report frames in the j^{th} sensing-by-proxy report frame set, the i^{th} sensing-by-proxy report request frame is indicative of retransmission of the portion of the sensing-by-proxy report frames specified by the frame index in the j^{th} sensing-by-proxy report frame set.

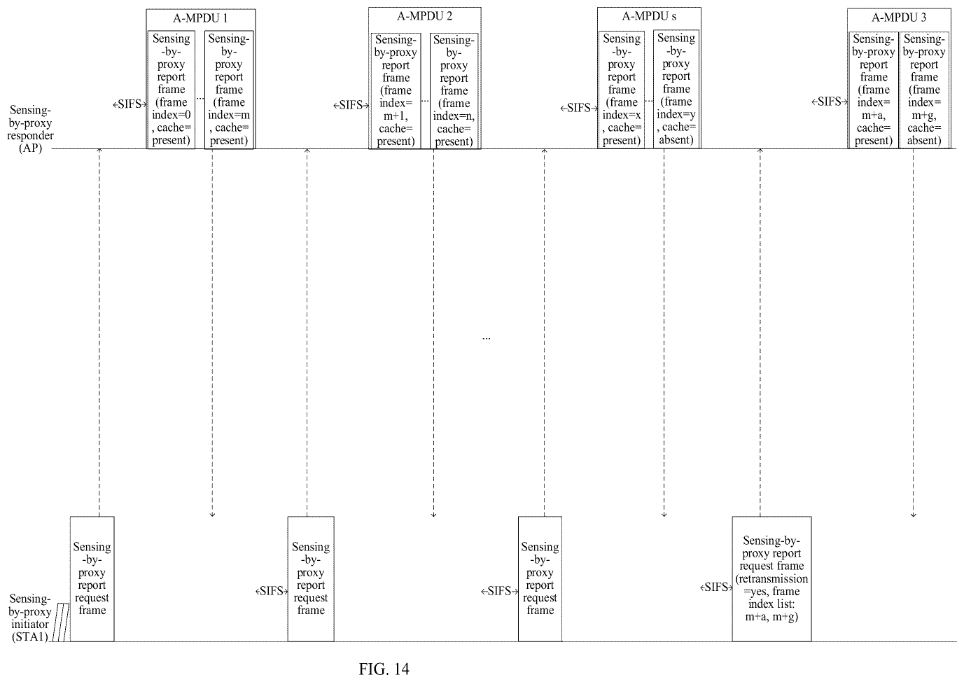

As shown in FIG. 14 illustratively, in the case that a last sensing-by-proxy report frame set (corresponding to the A-MPDUs) is retransmitted and the second sensing-by-proxy report frame set fails to be received, a value of a retransmit-or-not field “retry” in the i^{th} sensing-by-proxy report request frame is equal to the first value “true” and indicates a frame index “m+a, m+g” that needs to be retransmitted. In this case, the i^{th} sensing-by-proxy report request frame is indicative of retransmission of an (m+a)^{th} sensing-by-proxy report frame and an (m+g)^{th} sensing-by-proxy report frame in the second sensing-by-proxy report frame set.

In some embodiments, the frame index in FIG. 13 is represented by using a frame index bitmap corresponding to a single sensing-by-proxy report frame set. In the case that the (i−1)^{th} or j^{th} sensing-by-proxy report frame set that needs to be retransmitted includes m1 sensing-by-proxy report frames, the frame index bitmap includes m1 bits, a first bit in the frame index bitmap indicates whether the first sensing-by-proxy report frame needs to be retransmitted, a second bit in the frame index bitmap indicates whether the second sensing-by-proxy report frame needs to be retransmitted, a third bit in the frame index bitmap indicates whether the third sensing-by-proxy report frame needs to be retransmitted, and so on. In some embodiments, a value of 1 represents retransmission, and a value of 0 represents no retransmission. Alternatively, a value of 0 represents retransmission, and a value of 1 represents no retransmission. All bits in the frame index bitmap are set to 1 to indicate request of retransmission of the entire A-MPDU for which transmission fails.

In some embodiments, the frame indexes in FIG. 13 and FIG. 14 are represented by using a frame index bitmap corresponding to all the transmitted sensing-by-proxy report frame sets, such as all the sensing-by-proxy report frames corresponding to the first A-MPDU to the second A-MPDU in the drawings. In the case that all the transmitted sensing-by-proxy report frame sets include m2 sensing-by-proxy report frames, the frame index bitmap includes m2 bits, a first bit in the frame index bitmap indicates whether the first sensing-by-proxy report frame needs to be retransmitted, a second bit in the frame index bitmap indicates whether the second sensing-by-proxy report frame needs to be retransmitted, a third bit in the frame index bitmap indicates whether the third sensing-by-proxy report frame needs to be retransmitted, and so on. In some embodiments, a value of 1 represents retransmission, and a value of 0 represents no retransmission. Alternatively, the value of 0 represents retransmission, and the value of 1 represents no retransmission. All bits in the frame index bitmap are set to 1 to indicate request of all the transmitted sensing-by-proxy report frame sets.

In some embodiments, the frame index in FIG. 14 is represented by using a frame index bitmap corresponding to all sensing-by-proxy report frame sets, such as all sensing-by-proxy report frames corresponding to the first A-MPDU to a s^{th} A-MPDU in the drawings. In the case that all the sensing-by-proxy report frame sets include m3 sensing-by-proxy report frames, the frame index bitmap includes m3 bits, a first bit in the frame index bitmap indicates whether the first sensing-by-proxy report frame needs to be retransmitted, a second bit in the frame index bitmap indicates whether the second sensing-by-proxy report frame needs to be retransmitted, a third bit in the frame index bitmap indicates whether the third sensing-by-proxy report frame needs to be retransmitted, and so on. In some embodiments, a value of 1 represents retransmission, and a value of 0 represents no retransmission. Alternatively, the value of 0 represents retransmission, and the value of 1 represents no retransmission. All bits in the frame index bitmap are set to 1 to indicate request of retransmission of the entire A-MPDU for which transmission fails.

In some embodiments, the frame indexes in FIG. 13 and FIG. 14 are represented by using a frame index list. The frame index list carries the frame indexes of the sensing-by-proxy report frames that need to be retransmitted, and does not carry the frame indexes of the sensing-by-proxy report frames that do not need to be retransmitted, such as “m+a, m+g”.

The following embodiments are provided for the sequence form 2 (predefined timeout time).

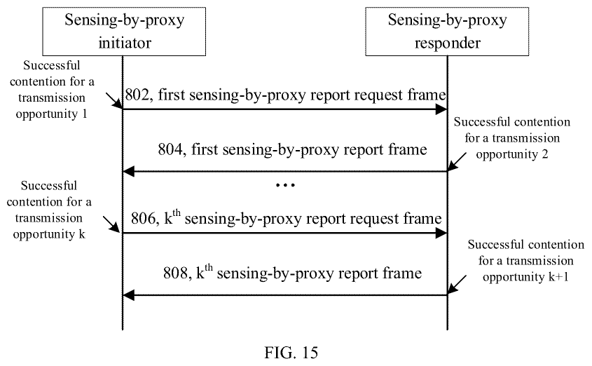

FIG. 15 is a flowchart of a method for reporting a sensing result according to other exemplary embodiments of the present disclosure. The embodiments are exemplified with the method being applicable to a sensing-by-proxy initiator and a sensing-by-proxy responder.

In S802, the sensing-by-proxy initiator transmits a first sensing-by-proxy report request frame to the sensing-by-proxy responder in response to a transmission opportunity.

The sensing-by-proxy initiator has successfully contended for a transmission opportunity in a wireless channel based on a channel backoff access process.

Upon successful contention for the transmission opportunity in the wireless channel, the sensing-by-proxy initiator transmits the first sensing-by-proxy report request frame to the sensing-by-proxy responder. Correspondingly, the sensing-by-proxy responder receives the first sensing-by-proxy report request frame.

In S804, the sensing-by-proxy responder transmits a first sensing-by-proxy report frame to the sensing-by-proxy initiator in response to successful contention for a transmission opportunity again upon receipt of the first sensing-by-proxy report request frame.

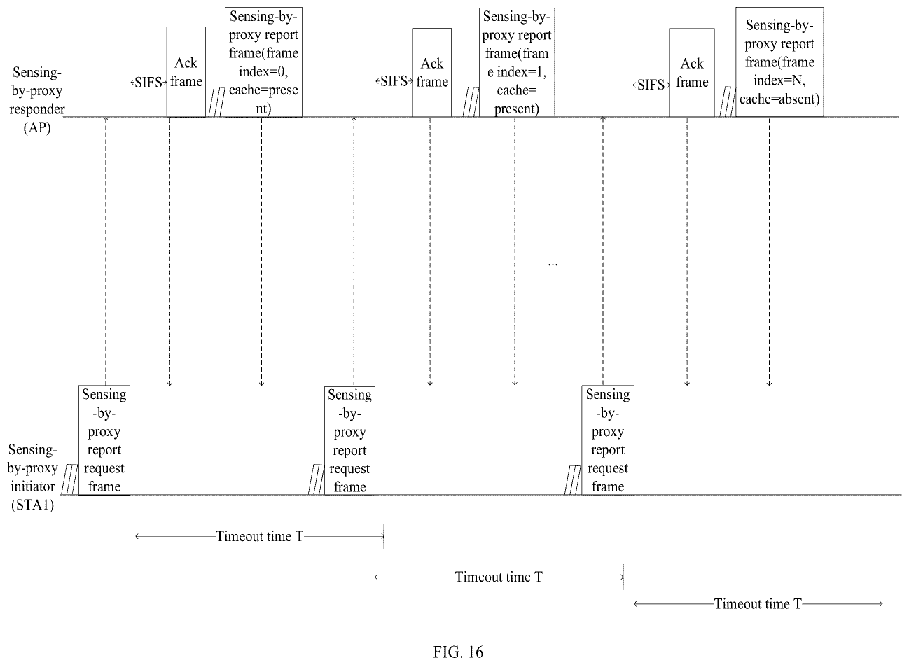

Different from the sequence form 1, as shown in FIG. 16, upon receiving the first sensing-by-proxy report request frame, the sensing-by-proxy responder needs to contend for another transmission opportunity. Upon successful contention for the other transmission opportunity, the sensing-by-proxy responder transmits the first sensing-by-proxy report frame to the sensing-by-proxy initiator. Correspondingly, the sensing-by-proxy initiator receives the first sensing-by-proxy report frame.

The sensing-by-proxy initiator caches at least one measurement result, one measurement result IS split into at least one frame data, and one sensing-by-proxy report frame carries one piece of frame data.

In some embodiments, each sensing-by-proxy report frame is further indicative of an “index” of the carried frame data. The index is indicative of an index of the frame data in the cache of the sensing-by-proxy responder. For example, the sensing-by-proxy responder caches three pieces of frame data, and the indexes of the three pieces of frame data are 0, 1, and 2, separately. The index may also be considered as the frame index of the sensing-by-proxy report frame.

In some embodiments, each sensing-by-proxy report frame further indicates whether the sensing-by-proxy responder has untransmitted cache data. In some embodiments, the sensing-by-proxy report frame carries a cache-or-not field. In the case that a value of the cache-or-not field is a first value, the sensing-by-proxy responder has untransmitted cache data; and in the case that a value of the cache-or-not field is a second value, the sensing-by-proxy responder has no untransmitted cache data, that is, all the measurement results have been transmitted. For example, the first value is 1, yes, or true, and the second value is 0, no, or false.

In S806, upon receiving a (k−1)^{th} sensing-by-proxy report frame, the sensing-by-proxy initiator successfully contends for a transmission opportunity and transmits a k^{th} sensing-by-proxy report request frame to the sensing-by-proxy responder.

Different from the sequence form 1, upon receiving the (k−1)^{th} sensing-by-proxy report frame, the sensing-by-proxy initiator needs to contend for another transmission opportunity. Upon successful contention for another transmission opportunity, the sensing-by-proxy initiator transmits the k^{th} sensing-by-proxy report request frame to the sensing-by-proxy responder. k is an integer. Correspondingly, the sensing-by-proxy responder receives the k^{th} sensing-by-proxy report request frame.

Illustratively, the k^{th} sensing-by-proxy report request frame is transmitted to the sensing-by-proxy responder in the case that the (k−1)^{th} sensing-by-proxy report frame indicates that the sensing-by-proxy responder has untransmitted cache data and the sensing-by-proxy initiator successfully contends for the transmission opportunity again.

In some embodiments, the sensing-by-proxy report frame carries the cache-or-not field “more”. In the case that a value of the cache-or-not field “more” is the first value “true”, the first value “true” indicates that the sensing-by-proxy responder has untransmitted cache data. In this case, the sensing-by-proxy initiator transmits the k^{th} sensing-by-proxy report request frame to the sensing-by-proxy responder in response to receiving the (k−1)^{th} sensing-by-proxy report frame and successful contention for the transmission opportunity.

In S808, the sensing-by-proxy responder transmits a k^{th} sensing-by-proxy report frame to the sensing-by-proxy initiator in response to successful contention for a transmission opportunity again upon receipt of the k^{th} sensing-by-proxy report request frame.

In the sequence form 2, each time the sensing-by-proxy initiator transmits a sensing-by-proxy report request frame, the sensing-by-proxy initiator needs to perform a channel backoff access process to acquire a transmission opportunity. Each sensing-by-proxy report request frame corresponds to a transmission opportunity, and different sensing-by-proxy report request frames correspond to different transmission opportunities.

Similarly, each time the sensing-by-proxy responder transmits a sensing-by-proxy report frame, the sensing-by-proxy responder needs to perform a channel backoff access process to acquire a transmission opportunity. Each sensing-by-proxy report frame corresponds to a transmission opportunity, and different sensing-by-proxy report frames correspond to different transmission opportunities.

In some embodiments, a time interval between the sensing-by-proxy report request frame and the sensing-by-proxy report frame of each pair cannot exceed a time interval T. The T is a predefined timeout time or timeout duration.

It should be noted that in FIG. 16, a serial number x in “successful contention for a transmission opportunity No. x” is illustrated by comprehensive counting based on the reporting process of the sensing result by both the sensing-by-proxy initiator and the sensing-by-proxy responder, and different serial numbers are only used for representing different transmission opportunities and contexts, but may not be completely consistent with the serial numbers of transmission opportunities acquired by an actual device as the actual device may have other transmission services.

### Unidirectional Ack Frame Mechanism:

In some embodiments, the sensing-by-proxy initiator further receives an Ack frame of the k^{th} sensing-by-proxy report request frame transmitted by the sensing-by-proxy responder. The Ack frame is transmitted by the sensing-by-proxy responder in the case that the SIFS is spaced by taking a reception end time of the k^{th} sensing-by-proxy report request frame as a start point. The k^{th} sensing-by-proxy report request frame and the Ack frame of the k^{th} sensing-by-proxy report request frame use a same transmission opportunity (acquired by the sensing-by-proxy initiator by contention).

As shown in FIG. 17 illustratively, the sensing-by-proxy initiator requests for the cache data (including a plurality of pieces of frame data) of the sensing-by-proxy responder one by one. Illustratively, the frame data of each request is successfully received by the sensing-by-proxy initiator.

In some embodiments, the sensing-by-proxy initiator transmits the first sensing-by-proxy report request frame to the sensing-by-proxy responder upon successful contention for the transmission opportunity, and the sensing-by-proxy responder contends for another transmission opportunity upon receiving the first sensing-by-proxy report request frame and starts to transmit the first sensing-by-proxy report frame within a predefined timeout time T. Upon receiving the first sensing-by-proxy report frame, the sensing-by-proxy initiator contends for another transmission opportunity, and continues to transmit the k^{th} sensing-by-proxy report request frame upon successful contention for another transmission opportunity, until all the data cached by the sensing-by-proxy responder is received.

Illustratively, the predefined timeout time T is generally used in request and response interaction of management frames, for example, 10 milliseconds, which is much larger than the SIFS.

In some embodiments, the sensing-by-proxy report request frame is a newly defined action frame. In some embodiments, the sensing-by-proxy report frame is an Action No Ack frame. In some embodiments, the sensing-by-proxy report frame adopts almost a same frame format as a measurement result report frame, only with a difference in a value of a public action field.

In some embodiments, the protected sensing-by-proxy report frame uses a same replay counter as other protected management frames in the case that the management frame protection function is enabled. In particular, in the case that the protected sensing-by-proxy report frame cannot use a same replay counter as the protected measurement result report frame, the protected sensing-by-proxy report frame belongs to a protected dual of public action frame category, and the protected measurement result report frame belongs to a protected sensing action frame category.

### Proxy Terminating Process:

As a method for implicitly terminating proxy sensing, the sensing-by-proxy requester carries the required duration of sensing measurement in the sensing requirement information in the sensing-by-proxy request frame, that is, how long it lasts before terminating the corresponding proxy sensing measurement process. The sensing-by-proxy responder needs to terminate the corresponding sensing measurement setup with a relevant sensing participant and release corresponding resources, such as cached measurement results and measurement setup information including measurement setup identifications.

In some embodiments, the sensing-by-proxy initiator transmits an m^{th} sensing-by-proxy report request frame to the sensing-by-proxy responder. The m^{th} sensing-by-proxy report request frame carries a terminate indication, and the terminate indication instructs the sensing-by-proxy responder to terminate the sensing measurement upon report of frame data corresponding to an m^{th} sensing-by-proxy report frame or sensing-by-proxy report frame set.

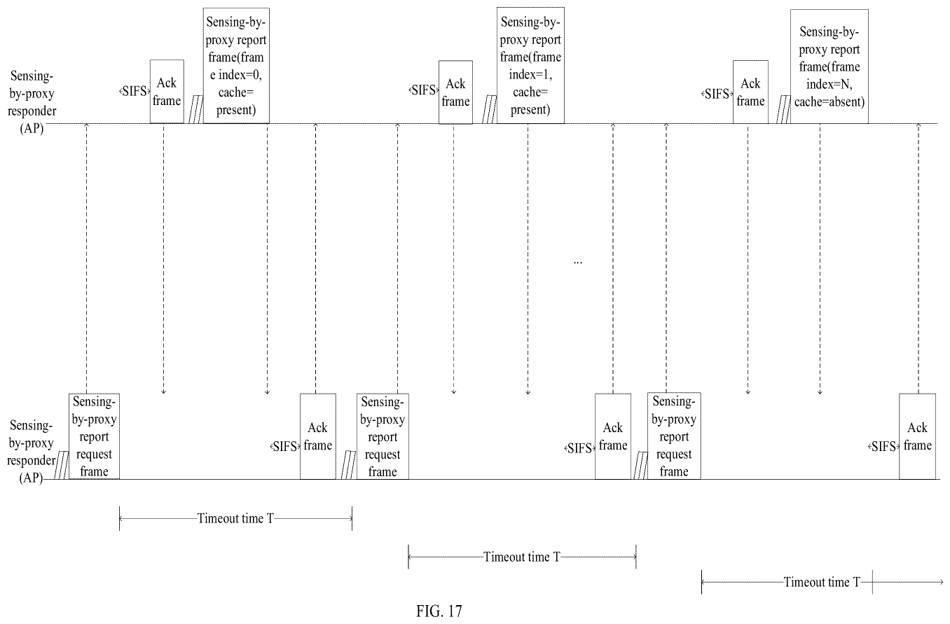

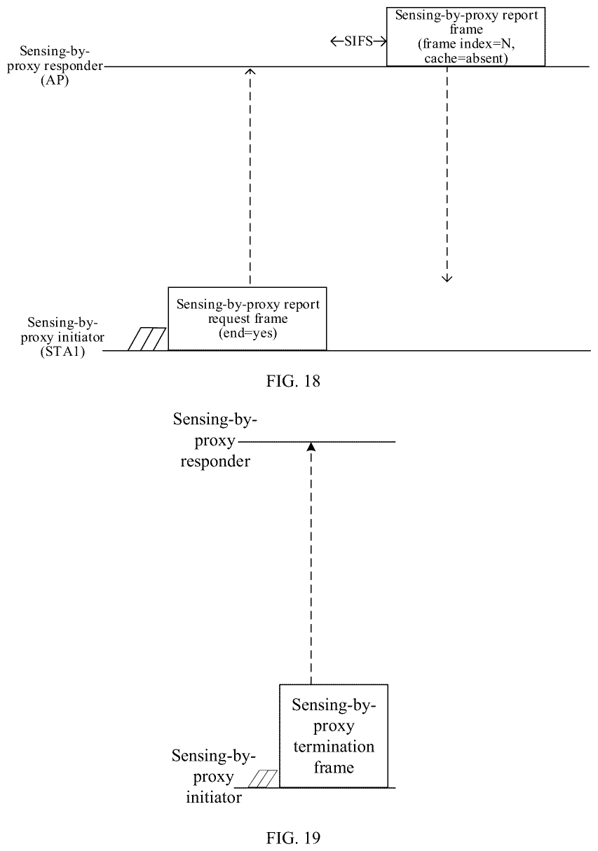

As shown in FIG. 18, the sensing-by-proxy requester further indicates the sensing-by-proxy responder in the sensing-by-proxy report request frame, and terminates the corresponding proxy sensing measurement process upon reporting the current frame data.

In some embodiments, the sensing-by-proxy initiator transmits a first sensing-by-proxy termination frame to the sensing-by-proxy responder. The first sensing-by-proxy termination frame instructs the sensing-by-proxy responder to terminate all or part of or at least one of the sensing measurements established by the sensing-by-proxy responder on behalf of the sensing-by-proxy initiator.

As shown in FIG. 19, the sensing-by-proxy initiator explicitly terminates the proxy sensing, that is, transmits a sensing-by-proxy termination frame (SBP termination), indicating to terminate all proxy sensing measurement sensing processes between them, or indicating to terminate one or more proxy sensing measurement processes between them.

In some embodiments, the sensing-by-proxy responder transmits a second sensing-by-proxy termination frame to the sensing-by-proxy initiator. The second sensing-by-proxy termination frame instructs the sensing-by-proxy initiator to terminate all or part of or at least one of the sensing measurements established by the sensing-by-proxy responder on behalf of the sensing-by-proxy initiator.

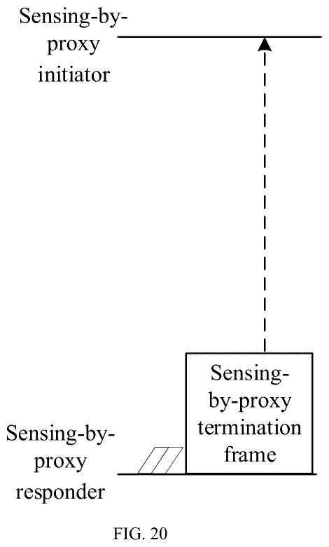

As shown in FIG. 20, the sensing-by-proxy responder explicitly terminates the proxy sensing, that is, transmits a sensing-by-proxy termination frame, indicating to terminate all proxy sensing measurement processes between them, or indicating to terminate one or more proxy sensing measurement processes between them.

### Sensing-by-Proxy Report Request Frame

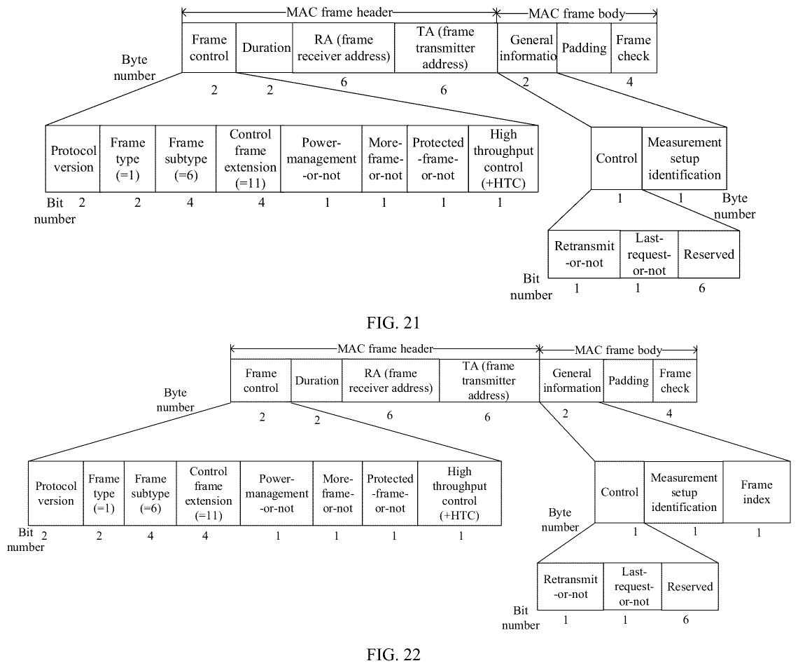

In the case that the sensing-by-proxy report request frame is a control frame:
a frame structure of an exemplary sensing-by-proxy report request frame is shown in FIG. 21, and the sensing-by-proxy report request frame (SBP report request frame) is defined as a new control frame.

A frame subtype value of 6 indicates that the frame is an extended control frame, and a control frame extension value of 11 (any value from 11 to 15) indicates that the frame is a sensing-by-proxy report request frame. This format is applicable to the flows shown in FIG. 8 and FIG. 9.

A control field indicates whether one or more subsequent fields are present.

A retransmit-or-not (retry) indicating bit instructs to request the sensing-by-proxy responder to retransmit the latest transmitted measurement result or frame data or sensing result. In some embodiments, the indicating bit is set to 1 to indicate retransmission, otherwise it is set to 0. In other embodiments, the indicating bit is set to 0 to indicate retransmission, otherwise it is set to 1. Illustratively, in the flows shown in FIG. 8 and FIG. 9, the indicating bit should be set in the first sensing-by-proxy report request frame to indicate no.

A last-request-or-not (last) indicating bit indicates whether the sensing-by-proxy responder is required to terminate the corresponding proxy sensing measurement process upon the current report. In some embodiments, the indicating bit is set to 1 to indicate to terminate the corresponding proxy sensing measurement process upon the current report, otherwise it is set to 0. In other embodiments, the indicating bit is set to 0 to indicate yes, otherwise it is set to 1.

A measurement setup identification (measurement setup ID) field indicates an identification of a measurement setup corresponding to the requested measurement result.

A frame structure of another exemplary sensing-by-proxy report request frame is shown in FIG. 22, and a retransmit-or-not (retry) indicating bit and a frame index are used. This format is applicable to the flows shown in FIG. 8 and FIG. 10.

The retransmit-or-not (retry) indicating bit instructs to request the sensing-by-proxy responder to retransmit the measurement result indicated by the frame index field. In some embodiments, the indicating bit is set to 1 to indicate yes, otherwise it is set to 0. In other embodiments, the indicating bit is set to 0 to indicate yes, otherwise it is set to 1. In the flows shown in FIG. 8 and FIG. 10, the indicating bit should be set in the first sensing-by-proxy report request frame to indicate no.

The frame index field indicates a corresponding index of the requested measurement frame data in the cache of the sensing-by-proxy responder. This field does not exist in the case that the retransmit-or-not indicating bit indicates no. The frame index field may also be considered as a frame data field, a block index field for cache data, or the like.

A frame structure of another exemplary sensing-by-proxy report request frame is shown in FIG. 23, and a retransmit-or-not (retry) indicating bit and a frame index bitmap are used. The frame index bitmap is based on a single sensing-by-proxy report frame set, or on all the transmitted sensing-by-proxy report frame sets, or on all sensing-by-proxy report frame sets. This format is applicable to the flows shown in FIG. 13 and FIG. 14.
In the case that the sensing-by-proxy report request frame is an action frame:

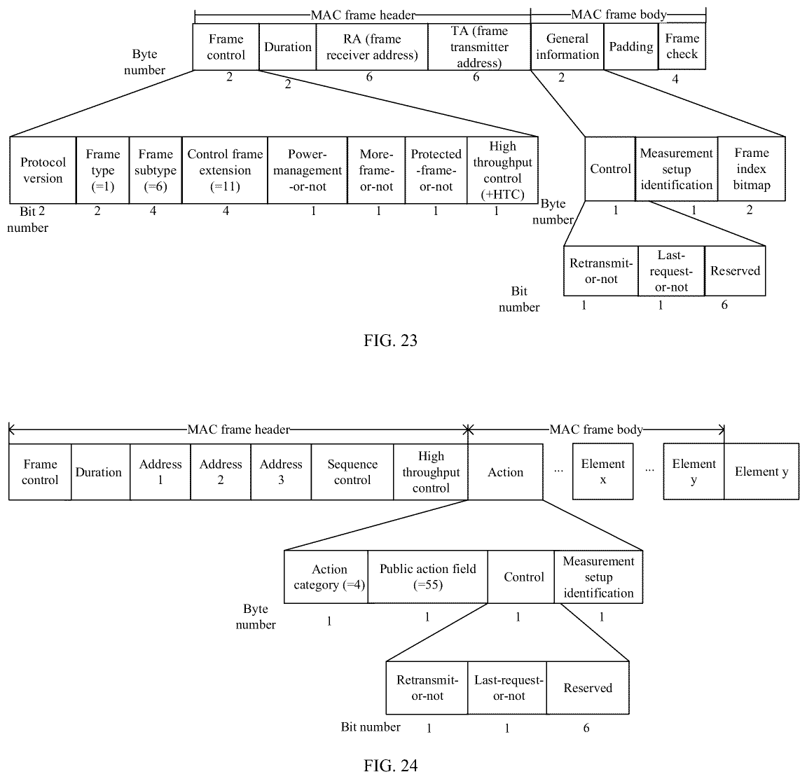

a frame structure of an exemplary sensing-by-proxy report request frame is shown in FIG. 24, and the sensing-by-proxy report request frame (SBP report request frame) is defined as a new action frame or an Action No Ack frame with an action category of 4, which indicates that the frame is a public action frame. A value of a public action field being 55 (any value in the range of 51 to 255) indicates that the frame is a sensing-by-proxy report request frame.

Some embodiments define a protected sensing-by-proxy report request frame (protected SBP report request frame) as a new action frame or an Action No Ack frame with an action category of 9, which indicates that the frame is a protected dual of public action. A value of a public action field being 35 (any value in the range of 33 to 255) indicates that the frame is a protected sensing-by-proxy report request frame. The fields following the public action field are completely consistent with the fields following the public action field of the aforementioned sensing-by-proxy report request frame, which are not repeated hereinafter.

This format is applicable to the illustrated flows associated with a unidirectional Ack frame or the illustrated flows associated with a bidirectional Ack frame.

A control field indicates whether one or more subsequent fields are present.

A retransmit-or-not (retry) indicating bit instructs to request the sensing-by-proxy responder to retransmit the measurement result just transmitted. In some embodiments, the indicating bit is set to 1 to indicate yes, otherwise it is set to 0. In other embodiments, the indicating bit is set to 0 to indicate yes, otherwise it is set to 1. In the illustrated flows associated with a unidirectional Ack frame or the illustrated flows associated with a bidirectional Ack frame, the indicating bit should be set in the first sensing-by-proxy report request frame to indicate no.

A last-request-or-not (last) indicating bit indicates whether the sensing-by-proxy responder is required to terminate the corresponding proxy sensing measurement process upon the current report. In some embodiments, the indicating bit is set to 1 to indicate yes, otherwise it is set to 0. In other embodiments, the indicating bit is set to 0 to indicate yes, otherwise it is set to 1.

A measurement setup identification (measurement setup ID) field indicates an identification of a measurement setup corresponding to the requested measurement result.

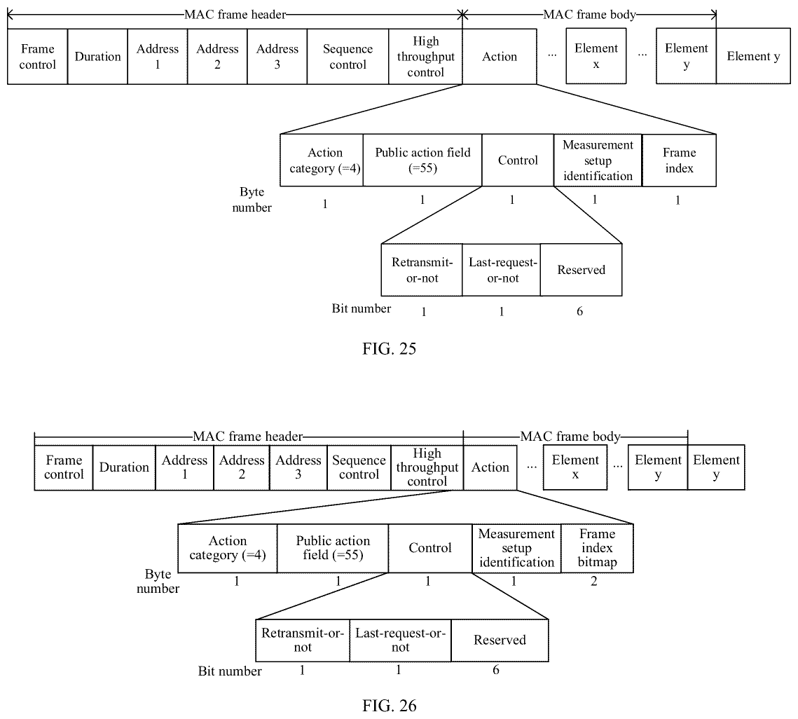

A frame structure of another exemplary sensing-by-proxy report request frame is shown in FIG. 25, and a retransmit-or-not (retry) indicating bit and a frame index are used. This format is applicable to a retransmission related flow with a frame index indication corresponding to a unidirectional Ack frame or a bidirectional Ack frame.

The retransmit-or-not (retry) indicating bit indicates to request the sensing-by-proxy responder to retransmit the measurement result indicated by the frame index or the frame data index field. In some embodiments, the indicating bit is set to 1 to indicate yes, otherwise it is set to 0. In other embodiments, the indicating bit is set to 0 to indicate yes, otherwise it is set to 1. In the retransmission related flow with a frame index indication corresponding to the unidirectional Ack frame or the bidirectional Ack frame, the indicating bit should be set in the first sensing-by-proxy report request frame to indicate no.

The frame index field indicates a corresponding index of the requested measurement frame data in the cache of the sensing-by-proxy responder. This field does not exist in the case that the retransmit-or-not indicating bit indicates no.

A frame structure of another exemplary sensing-by-proxy report request frame is described in FIG. 26, and a retransmit-or-not (retry) indicating bit and a frame index bitmap are used. The frame index bitmap is based on a single sensing-by-proxy report frame set, or on all the transmitted sensing-by-proxy report frame sets, or on all sensing-by-proxy report frame sets. This format is applicable to a retransmission related flow with a frame index bitmap corresponding to a unidirectional Ack frame or a bidirectional Ack frame.

### Sensing-by-Proxy Report Frame

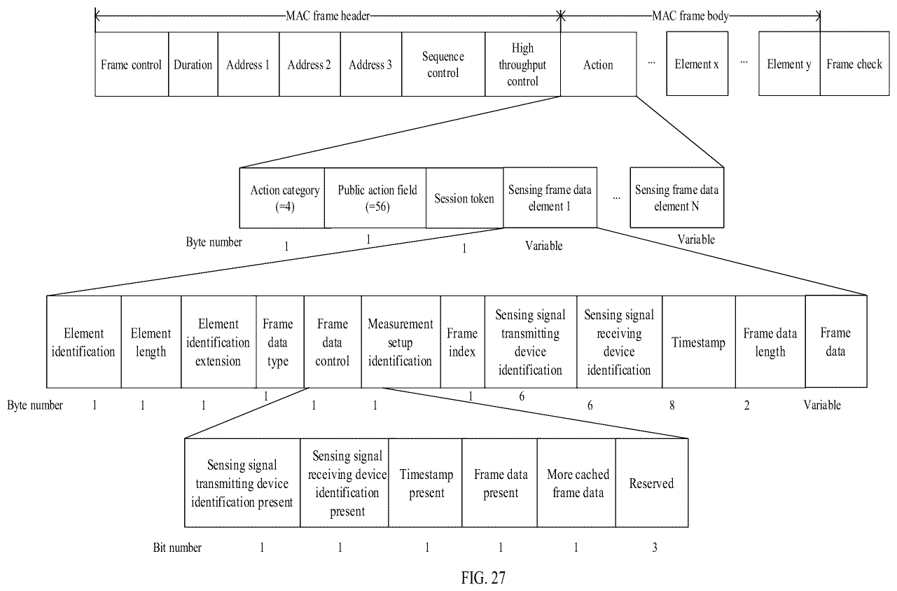

A frame structure of an exemplary sensing-by-proxy report frame is shown in FIG. 27, and the sensing-by-proxy report frame (SBP report frame) is defined as a new action frame or an Action No Ack frame with an action category of 4, which indicates that the frame is a public action frame. A value of a public action field being 56 (any value in the range of 51 to 255) indicates that the frame is a sensing-by-proxy report frame.

Some embodiments define a protected sensing-by-proxy report frame (protected SBP report frame) as a new action frame or an Action No Ack frame with an action category of 38 (which can be any value in the range of 38 to 255), which indicates that the frame is a sensing action frame. A value of a sensing action field being 6 (any value in the range of 0 to 255) indicates that the frame is a protected sensing-by-proxy report frame. The fields following the sensing action field are completely consistent with the fields following the public action field of the aforementioned sensing-by-proxy report frame, which are not repeated hereinafter.

Some embodiments define a protected sensing-by-proxy report frame (protected SBP report frame) as a new action frame or an Action No Ack frame with an action category of 9, which indicates that the frame is a protected dual of public action. A value of a public action field being 36 (any value in the range of 33 to 255) indicates that the frame is a protected sensing-by-proxy report frame. The fields following the public action field are completely consistent with the fields following the public action field of the aforementioned sensing-by-proxy report frame, which are not repeated hereinafter.

A sensing measurement report type field indicates a type of frame data in an element. In some embodiments, 0 represents channel state information (CSI, which generally refers to a channel frequency response (CFR)), 1 represents a beam signal-to-noise ratio (beam SNR), 2 represents CSI amplitude only, 3 represents CSI phase only, 4 represents an angle of arrival (AoA), 5 represents an angle of departure (AoD), 6 represents CSI and AoA, 7 represents CSI and AoD, 8 represents Doppler information, and 9 to 255 are reserved. The values of the field are only an exemplary description, and may be set to other values, as long as the value corresponding to each measurement type is different from those of other measurement types. For example, a value of 2 represents the channel state information; and a value of 1 represents the beam signal-to-noise ratio. For example, a value of 8 represents the channel state information, and a value of 15 represents the beam signal-to-noise ratio, and the like.

A sensing measurement report control field indicates whether one or more subsequent fields are present in an element where it is located.

A sensing signal transmitting device identification present (TX ID present) indicating bit indicates whether a sensing signal transmitting device identification field in an element is present. In some embodiments, the indicating bit is set to 1 to indicate yes, otherwise it is set to 0. In other embodiments, the indicating bit is set to 0 to indicate yes, otherwise it is set to 1.

A sensing signal receiver identification present (RX ID present) indicating bit indicates whether a sensing signal receiver identification field in an element is present. In some embodiments, the indicating bit is set to 1 to indicate yes, otherwise it is set to 0. In other embodiments, the indicating bit is set to 0 to indicate yes, otherwise it is set to 1.

A timestamp present indicating bit indicates whether a timestamp field in an element is present. In some embodiments, the indicating bit is set to 1 to indicate yes, otherwise it is set to 0. In other embodiments, the indicating bit is set to 0 to indicate yes, otherwise it is set to 1.

A sensing measurement report present indicating bit indicates whether a frame data field in an element is present. In some embodiments, the indicating bit is set to 1 to indicate yes, otherwise it is set to 0. In other embodiments, the indicating bit is set to 0 to indicate yes, otherwise it is set to 1.

A more cached report indicating bit indicates whether more cached measurement result data needs to be transmitted upon transmission of the frame data in an element. In some embodiments, the indicating bit is set to 1 to indicate yes, otherwise it is set to 0. In other embodiments, the indicating bit is set to 0 to indicate yes, otherwise it is set to 1.

A measurement setup identification (measurement setup ID) field indicates an identification of a measurement setup corresponding to the frame data in an element where it is located.

A frame index (report index) indicates a corresponding index of the frame data in an element in the cache of the sensing-by-proxy responder. In some embodiments, 0 represents the first, 1 represents the second, and so on. In other embodiments, it is also possible that 1 represents the first, 2 represents the second, and so on.

A sensing signal transmitting device identification (TX ID) field indicates an identification of a transmitter of a sensing signal for generating the frame data in an element, which is generally an MAC address of the device.

A sensing signal receiver identification (RX ID) field indicates an identification of a receiver of a sensing signal for generating the frame data in an element, which is generally an MAC address of the device.

A measurement timestamp field indicates a measurement timestamp corresponding to the frame data in an element, for example, a transmission time or a receipt time of the sensing signal for generating the measurement result data.

A frame data length (report length) field indicates a length of the frame data in bytes in an element.

A frame data (measurement report) field indicates the frame data in an element.

### Sensing-by-Proxy Termination Frame

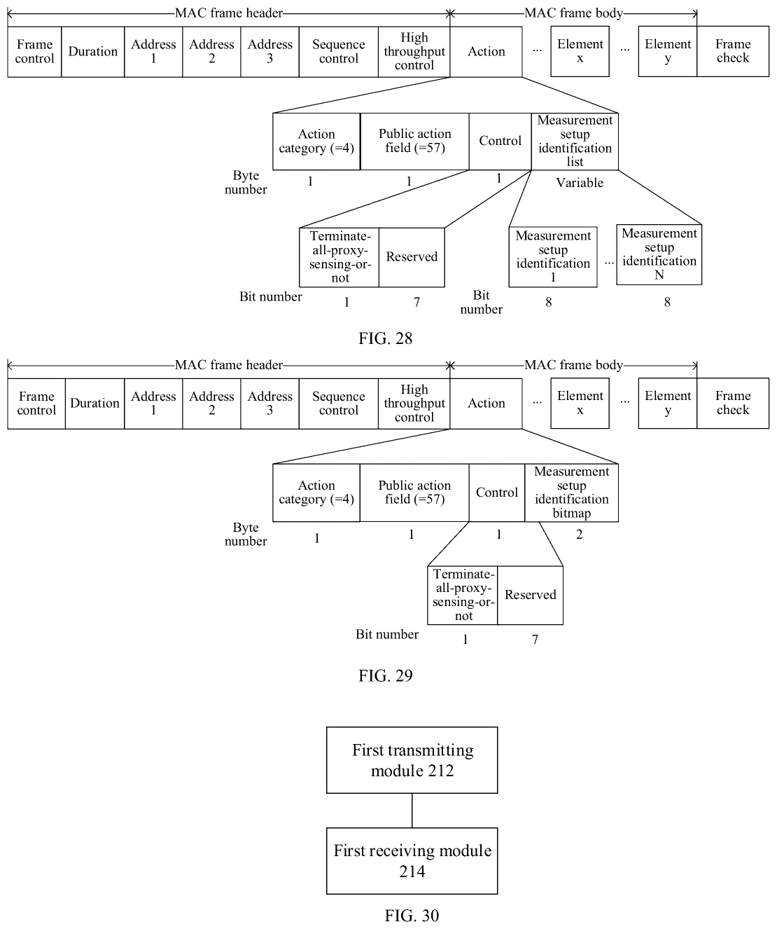

A frame structure of an exemplary sensing-by-proxy termination frame is shown in FIG. 28, and the sensing-by-proxy termination frame (SBP termination frame) is defined as a new action frame or an Action No Ack frame with an action category of 4, which indicates that the frame is a public action frame. A value of a public action field being 57 (any value in the range of 51 to 255) indicates that the frame is a sensing-by-proxy termination frame.

Some embodiments define a protected sensing-by-proxy termination frame (protected SBP termination frame) as a new action frame or an Action No Ack frame with an action category of 9, which indicates that the frame is a protected dual of public action. A value of a public action field being 37 (any value in the range of 33 to 255) indicates that the frame is a protected sensing-by-proxy termination frame. The fields following the public action field are completely consistent with the fields following the public action field of the aforementioned sensing-by-proxy termination frame, which are not repeated hereinafter.

A control field indicates whether one or more subsequent fields are present.

A terminate-all-proxy-sensing-or-not (terminate all) indicating bit indicates whether to terminate all proxy sensing measurement processes between the sensing-by-proxy requester and the sensing-by-proxy responder. In some embodiments, the indicating bit is set to 1 to indicate yes, otherwise it is set to 0. In other embodiments, the indicating bit is set to 0 to indicate yes, otherwise it is set to 1.

A measurement setup identification list (measurement setup ID list) field instructs to terminate one or more proxy sensing measurement processes between the sensing-by-proxy requester and the sensing-by-proxy responder. This field is absent in the case that the terminate-all-proxy-sensing-or-not (terminate all) indicating bit indicates yes.

A frame structure of an exemplary sensing-by-proxy termination frame is shown in FIG. 29, and a measurement setup identification bitmap is used instead of the measurement setup identification list in FIG. 21.

A measurement setup identification bitmap (measurement setup ID bitmap) field instructs to terminate one or more proxy sensing measurement processes between the sensing-by-proxy requester and the sensing-by-proxy responder. This field is absent in the case that the terminate-all-proxy-sensing-or-not (terminate all) indicating bit indicates yes. In some embodiments, a first bit B0 is set to 1 to indicate to terminate the sensing measurement process with a measurement setup identification of 1, a second bit B1 is set to 1 to indicate to terminated the sensing measurement process with a measurement setup identification of 2, and so on. In some embodiments, the first bit B0 is set to 0 to indicate to terminate the sensing measurement process with a measurement setup identification of 1, the second bit B1 is set to 0 to indicate to terminate the sensing measurement process with a measurement setup identification of 2, and so on.

FIG. 30 shows a block diagram illustrating an apparatus for reporting a sensing result according to some exemplary embodiments of the present disclosure. The apparatus is practiced as a sensing-by-proxy initiator or a component in a sensing-by-proxy initiator. The apparatus includes the following modules.

A first transmitting module 212 is configured to transmit a sensing-by-proxy report request frame to a sensing-by-proxy responder, where the sensing-by-proxy report request frame is for requesting the sensing-by-proxy responder to report the sensing result.

A first receiving module 214 is configured to receive a sensing-by-proxy report frame or a sensing-by-proxy report frame set from the sensing-by-proxy responder, wherein the sensing-by-proxy report frame or the sensing-by-proxy report frame set is fed back and transmitted by the sensing-by-proxy responder, and carries the sensing result.

In some embodiments, a time interval between the sensing-by-proxy report request frame and the sensing-by-proxy report frame adjacent to each other is one SIFS. Alternatively, a time interval between the sensing-by-proxy report request frame and the sensing-by-proxy report frame set adjacent to each other is an SIFS.

In some embodiments, the first transmitting module 212 is configured to transmit a first sensing-by-proxy report request frame to the sensing-by-proxy responder in response to successful contention for a transmission opportunity; and transmit an i^{th} sensing-by-proxy report request frame to the sensing-by-proxy responder upon elapse of the SIFS from a reception end time of an (i−1)^{th} sensing-by-proxy report frame or sensing-by-proxy report frame set;

i is an integer greater than 1, and the (i−1)^{th} sensing-by-proxy report frame or sensing-by-proxy report frame set is transmitted by the sensing-by-proxy responder upon elapse of the SIFS from a reception end time of an (i−1)^{th} sensing-by-proxy report request frame.

In some embodiments, the first transmitting module 212 is configured to transmit, in the case that the (i−1)^{th} sensing-by-proxy report frame or sensing-by-proxy report frame set indicates that the sensing-by-proxy responder has untransmitted cache data, the i^{th} sensing-by-proxy report request frame to the sensing-by-proxy responder upon elapse of the SIFS from the reception end time of the (i−1)^{th} sensing-by-proxy report frame or sensing-by-proxy report frame set.

In some embodiments, in the case that the (i−1)^{th} sensing-by-proxy report frame or sensing-by-proxy report frame set fails to be received, the i^{th} sensing-by-proxy report request frame is indicative of retransmission of frame data or a measurement result or a sensing result corresponding to the (i−1)^{th} sensing-by-proxy report frame or sensing-by-proxy report frame set,
where the sensing result includes at least one measurement result, and the frame data includes all data of one measurement result, or partial data of the one measurement result, or data of at least two measurement results.

In some embodiments, the first transmitting module 212 is configured to transmit, in the case that the (i−1)^{th} sensing-by-proxy report frame or sensing-by-proxy report frame set indicates that the sensing-by-proxy responder has no untransmitted cache data and a j^{th} sensing-by-proxy report frame or sensing-by-proxy report frame set fails to be received, the i^{th} sensing-by-proxy report request frame to the sensing-by-proxy responder upon elapse of the SIFS from the reception end time of the (i−1)^{th} sensing-by-proxy report frame or sensing-by-proxy report frame set, where the i^{th} sensing-by-proxy report request frame is indicative of retransmission of frame data in the j^{th} sensing-by-proxy report frame or sensing-by-proxy report frame set;
j is a positive integer not greater than i−1.

In some embodiments, the sensing-by-proxy report request frame is a control frame or an action frame.

In some embodiments, a time interval between the sensing-by-proxy report request frame and the sensing-by-proxy report frame adjacent to each other is not greater than a timeout time T; or, a time interval between the sensing-by-proxy report request frame and the sensing-by-proxy report frame set adjacent to each other is not greater than a timeout time T.

In some embodiments, the first transmitting module 212 is configured to transmit a k^{th} sensing-by-proxy report request frame to the sensing-by-proxy responder in response to successful contention for a transmission opportunity by the sensing-by-proxy initiator, where k is a positive integer.

The first receiving module 214 is configured to receive a k^{th} sensing-by-proxy report frame or sensing-by-proxy report frame set transmitted by the sensing-by-proxy responder, where the k^{th} sensing-by-proxy report frame or sensing-by-proxy report frame set is transmitted by the sensing-by-proxy responder in response to successful contention for a transmission opportunity again by the sensing-by-proxy responder upon receipt of the k^{th} sensing-by-proxy report request frame.

In some embodiments, the first receiving module 214 is configured to receive an Ack frame of the k^{th} sensing-by-proxy report request frame transmitted by the sensing-by-proxy responder, where the Ack frame is transmitted by the sensing-by-proxy responder in a case that the SIFS is spaced by taking a reception end time of the k^{th} sensing-by-proxy report request frame as a start point.

In some embodiments, the first transmitting module 212 is configured to transmit an Ack frame of the k^{th} sensing-by-proxy report frame or sensing-by-proxy report frame set to the sensing-by-proxy responder upon elapse of the SIFS from a reception end time of the k^{th} sensing-by-proxy report frame or sensing-by-proxy report frame set.

In some embodiments, the first transmitting module 212 is configured to transmit a (k+1)^{th} sensing-by-proxy report request frame to the sensing-by-proxy responder in the case that the k^{th} sensing-by-proxy report frame or sensing-by-proxy report frame set indicates that the sensing-by-proxy responder has untransmitted cache data and successfully contends for the transmission opportunity again.

In some embodiments, in the case that the k^{th} sensing-by-proxy report frame or sensing-by-proxy report frame set fails to be received, the (k+1)^{th} sensing-by-proxy report request frame is indicative of retransmission of frame data or a measurement result or a sensing result corresponding to the k^{th} sensing-by-proxy report frame or sensing-by-proxy report frame set,
where the sensing result includes at least one measurement result, and the frame data includes all data of one measurement result, or partial data of the one measurement result, or data of at least two measurement results.

In some embodiments, the first transmitting module 212 is configured to transmit the (k+1)^{th} sensing-by-proxy report request frame to the sensing-by-proxy responder in the case that the k^{th} sensing-by-proxy report frame or sensing-by-proxy report frame set is not received upon the timeout time T corresponding to the k^{th} sensing-by-proxy report request frame and the transmission opportunity is acquired again.

Alternatively, the first transmitting module 212 is configured to transmit the (k+1)^{th} sensing-by-proxy report request frame to the sensing-by-proxy responder in the case that the k^{th} sensing-by-proxy report frame or sensing-by-proxy report frame set fails to be received prior to the timeout time T corresponding to the k^{th} sensing-by-proxy report request frame and the transmission opportunity is acquired again.

In some embodiments, the first transmitting module 212 is configured to transmit the (k+1)^{th} sensing-by-proxy report request frame to the sensing-by-proxy responder in the case that the k^{th} sensing-by-proxy report frame or sensing-by-proxy report frame set indicates that the sensing-by-proxy responder has no untransmitted cache data, a p^{th} sensing-by-proxy report frame or sensing-by-proxy report frame set has failed to be received, and the transmission opportunity is successfully contended again, where the (k+1)^{th} sensing-by-proxy report request frame is indicative of retransmission of frame data or a measurement result or a sensing result corresponding to the p^{th} sensing-by-proxy report frame or sensing-by-proxy report frame set,
where the sensing result includes at least one measurement result, the frame data includes all data of one measurement result, or partial data of the one measurement result, or data of at least two measurement results, and p is a positive integer not greater than k.

In some embodiments, the sensing-by-proxy report request frame is an action frame.

In some embodiments, the sensing-by-proxy report frame or the sensing-by-proxy report frame set carries a piece of frame data, where the piece of frame data is a medium access control management protocol data unit (MMPDU), and the piece of frame data includes partial data of one measurement result in the sensing result, or all data of the one measurement result, or data of at least two measurement results.

In some embodiments, in the case that at least two pieces of the frame data carry data belonging to a same measurement result, the at least two pieces of the frame data belong to the same aggregate medium access control protocol data unit (A-MPDU).

In some embodiments, the first transmitting module 212 is configured to transmit a sensing-by-proxy request frame to the sensing-by-proxy responder, where the sensing-by-proxy request frame carries a requested frequency of the sensing result.

In some embodiments, the first sensing-by-proxy report request frame carries the requested frequency of the sensing result; or, the (i−1)^{th} sensing-by-proxy report request frame carries a transmission time of an i^{th} sensing-by-proxy report request frame.

In some embodiments, the first transmitting module 212 is configured to transmit an m^{th} sensing-by-proxy report request frame to the sensing-by-proxy responder, where the m^{th} sensing-by-proxy report request frame carries a terminate indication, where the terminate indication instructs the sensing-by-proxy responder to terminate the sensing measurement upon report of frame data corresponding to an m^{th} sensing-by-proxy report frame or sensing-by-proxy report frame set.

Alternatively, the first transmitting module 212 is configured to transmit a first sensing-by-proxy termination frame to the sensing-by-proxy responder, where the first sensing-by-proxy termination frame instructs the sensing-by-proxy responder to terminate all or part of or at least one of sensing measurements established by the sensing-by-proxy responder on behalf of the sensing-by-proxy initiator.

Alternatively, the first receiving module 214 is configured to receive a second sensing-by-proxy termination frame transmitted by the sensing-by-proxy responder, where the second sensing-by-proxy termination frame instructs the sensing-by-proxy initiator to terminate all or part of or at least one of sensing measurements established by the sensing-by-proxy responder on behalf of the sensing-by-proxy initiator.

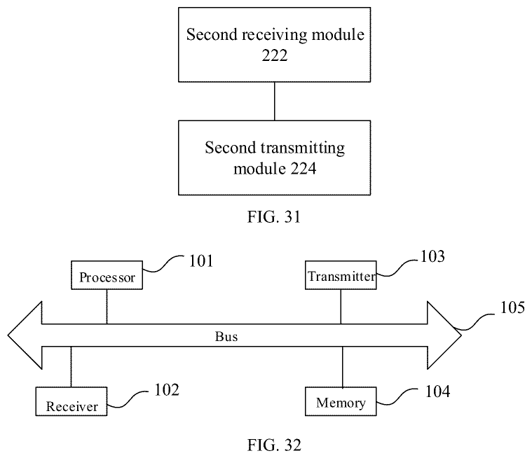

FIG. 31 shows a block diagram illustrating an apparatus for reporting a sensing result according to some exemplary embodiments of the present disclosure. The apparatus is practiced as a sensing-by-proxy responder or a component in a sensing-by-proxy responder. The apparatus includes a second receiving module 222 and a second transmitting module 224.

The second receiving module 222 is configured to receive a sensing-by-proxy report request frame transmitted by a sensing-by-proxy initiator, where the sensing-by-proxy report request frame is for requesting the apparatus to report the sensing result.

The second transmitting module 224 is configured to transmit a sensing-by-proxy report frame or a sensing-by-proxy report frame set to the sensing-by-proxy transmitter, where the sensing-by-proxy report frame or the sensing-by-proxy report frame set carries the sensing result.

In some embodiments, a time interval between the sensing-by-proxy report request frame and the sensing-by-proxy report frame adjacent to each other is one SIFS; or, a time interval between the sensing-by-proxy report request frame and the sensing-by-proxy report frame set adjacent to each other is an SIFS.

In some embodiments, the second transmitting module 224 is configured to transmit a first sensing-by-proxy report frame or sensing-by-proxy report frame set to the sensing-by-proxy transmitter upon elapse of the SIFS from a reception end time of a first sensing-by-proxy report request frame.

The second transmitting module 224 is configured to transmit an i^{th} sensing-by-proxy report frame or sensing-by-proxy report frame set to the sensing-by-proxy transmitter upon elapse of the SIFS from a reception end time of an i^{th} sensing-by-proxy report request frame,
i is an integer greater than 1, and the i^{th} sensing-by-proxy report request frame is transmitted by the sensing-by-proxy initiator upon elapse of the SIFS from a reception end time of an (i−1)^{th} sensing-by-proxy report frame or sensing-by-proxy report frame set.

In some embodiments, the first sensing-by-proxy report frame and the i^{th} sensing-by-proxy report frame further indicate whether the sensing-by-proxy responder has untransmitted cache data; or, the first sensing-by-proxy report frame set and the i^{th} sensing-by-proxy report frame set further indicate whether the sensing-by-proxy responder has untransmitted cache data.

In some embodiments, the second transmitting module 224 is configured to transmit, in the case that the i^{th} sensing-by-proxy report request frame is indicative of retransmission of frame data or a measurement result or a sensing result corresponding to the (i−1)^{th} sensing-by-proxy report frame or sensing-by-proxy report frame set, the i^{th} sensing-by-proxy report frame or sensing-by-proxy report frame set to the sensing-by-proxy transmitter upon elapse of the SIFS from the reception end time of the i^{th} sensing-by-proxy report request frame, where the i^{th} sensing-by-proxy report frame or sensing-by-proxy report frame set carries retransmission data corresponding to the (i−1)^{th} sensing-by-proxy report frame or sensing-by-proxy report frame set,
where the sensing result includes at least one measurement result, and the frame data includes all data of one measurement result, or partial data of the one measurement result, or data of at least two measurement results.

In some embodiments, the second transmitting module 224 is configured to transmit, in the case that the i^{th} sensing-by-proxy report request frame is indicative of retransmission of frame data or a measurement result or a sensing result corresponding to a j^{th} sensing-by-proxy report frame or sensing-by-proxy report frame set, the i^{th} sensing-by-proxy report frame or sensing-by-proxy report frame set to the sensing-by-proxy transmitter upon elapse of the SIFS from the reception end time of the i^{th} sensing-by-proxy report request frame, where the i^{th} sensing-by-proxy report frame or sensing-by-proxy report frame set carries retransmission data corresponding to the j^{th} sensing-by-proxy report frame or sensing-by-proxy report frame set,
where the sensing result includes at least one measurement result, the frame data includes all data of one measurement result, or partial data of the one measurement result, or data of at least two measurement results, and j is a positive integer not greater than i−1.

In some embodiments, the sensing-by-proxy report request frame is a control frame or an action frame.

In some embodiments, a time interval between the sensing-by-proxy report request frame and the sensing-by-proxy report frame adjacent to each other is not greater than a timeout time T; or, a time interval between the sensing-by-proxy report request frame and the sensing-by-proxy report frame set adjacent to each other is not greater than a timeout time T.

In some embodiments, the second transmitting module 224 is configured to transmit a k^{th} sensing-by-proxy report frame or sensing-by-proxy report frame set to the sensing-by-proxy transmitter in response to successful contention for a transmission opportunity again upon receipt of a k^{th} sensing-by-proxy report request frame,
k is a positive integer, and the k^{th} sensing-by-proxy report request frame is transmitted by the sensing-by-proxy initiator in the case that the transmission opportunity is successfully contended.

In some embodiments, the second transmitting module 224 is configured to transmit an Ack frame of the k^{th} sensing-by-proxy report request frame to the sensing-by-proxy initiator upon elapse of the SIFS from a reception end time of the k^{th} sensing-by-proxy report request frame.

In some embodiments, the second receiving module 222 is configured to receive an Ack frame of the k^{th} sensing-by-proxy report frame or sensing-by-proxy report frame set transmitted by the sensing-by-proxy initiator, where the Ack frame is transmitted by the sensing-by-proxy initiator in a case that the SIFS is spaced by taking a reception end time of the k^{th} sensing-by-proxy report frame or sensing-by-proxy report frame set as a start point.

In some embodiments, the k^{th} sensing-by-proxy report frame or sensing-by-proxy report frame set further indicates whether the sensing-by-proxy responder has untransmitted cache data.

In some embodiments, the second transmitting module 224 is configured to transmit a (k+1)^{th} sensing-by-proxy report frame or sensing-by-proxy report frame set to the sensing-by-proxy transmitter in the case that a (k+1)^{th} sensing-by-proxy report request frame is indicative of retransmission of frame data or a measurement result or a sensing result corresponding to the k^{th} sensing-by-proxy report frame or sensing-by-proxy report frame set and the second receiving module 222 successfully contends for the transmission opportunity again upon receipt of the (k+1)^{th} sensing-by-proxy report request frame, where the (k+1)^{th} sensing-by-proxy report frame or sensing-by-proxy report frame set carries retransmission data corresponding to the k^{th} sensing-by-proxy report frame or sensing-by-proxy report frame set,
where the sensing result includes at least one measurement result, and the frame data includes all data of one measurement result, or partial data of the one measurement result, or data of at least two measurement results.

In some embodiments, the (k+1)^{th} sensing-by-proxy report request frame is transmitted by the sensing-by-proxy initiator in the case that the k^{th} sensing-by-proxy report frame or sensing-by-proxy report frame set is not received upon the timeout time T corresponding to the k^{th} sensing-by-proxy report request frame and the transmission opportunity is acquired again; or, the (k+1)^{th} sensing-by-proxy report request frame is transmitted by the sensing-by-proxy initiator in the case that the k^{th} sensing-by-proxy report frame or sensing-by-proxy report frame set fails to be received prior to the timeout time T corresponding to the k^{th} sensing-by-proxy report request frame and the transmission opportunity is acquired again.

In some embodiments, the second transmitting module 224 is configured to transmit a (k+1)^{th} sensing-by-proxy report frame or sensing-by-proxy report frame set to the sensing-by-proxy transmitter in the case that the (k+1)^{th} sensing-by-proxy report request frame is indicative of retransmission of frame data or a measurement result or a sensing result corresponding to a p^{th} sensing-by-proxy report frame or sensing-by-proxy report frame set and the second receiving module 222 successfully contends for the transmission opportunity again upon receipt of the (k+1)^{th} sensing-by-proxy report request frame, where the (k+1)^{th} sensing-by-proxy report frame or sensing-by-proxy report frame set carries retransmission data corresponding to the p^{th} sensing-by-proxy report frame or sensing-by-proxy report frame set,
where the sensing result includes at least one measurement result, the frame data includes all data of one measurement result, or partial data of the one measurement result, or data of at least two measurement results, and p is a positive integer not greater than k.

In some embodiments, the sensing-by-proxy report request frame is an action frame.

In some embodiments, the sensing-by-proxy report frame or the sensing-by-proxy report frame set carries a piece of frame data, where the piece of frame data is a medium access control management protocol data unit (MMPDU), and the piece of frame data includes partial data of one measurement result in the sensing result, or all data of the one measurement result, or data of at least two measurement results.

In some embodiments, in the case that at least two pieces of the frame data carry data belonging to a same measurement result, the at least two pieces of the frame data belong to the same aggregate medium access control protocol data unit (A-MPDU).

In some embodiments, the second receiving module 222 is configured to receive a sensing-by-proxy request frame transmitted by the sensing-by-proxy initiator, where the sensing-by-proxy request frame carries a requested frequency of the sensing result.

In some embodiments, the first sensing-by-proxy report request frame carries a requested frequency of the sensing result.

Alternatively, the (i−1)^{th} sensing-by-proxy report request frame carries a transmission time of an i^{th} sensing-by-proxy report request frame.

In some embodiments, the second receiving module 222 is configured to receive an m^{th} sensing-by-proxy report request frame transmitted by the sensing-by-proxy initiator, where the m^{th} sensing-by-proxy report request frame carries a terminate indication, and the terminate indication instructs the sensing-by-proxy responder to terminate the sensing measurement after report of frame data corresponding to an m^{th} sensing-by-proxy report frame or sensing-by-proxy report frame set.

Alternatively, the second receiving module 222 is configured to receive a first sensing-by-proxy termination frame transmitted by the sensing-by-proxy initiator, where the first sensing-by-proxy termination frame instructs the sensing-by-proxy responder to terminate all or part of or at least one of sensing measurements established by the sensing-by-proxy responder on behalf of the sensing-by-proxy initiator.

Alternatively, the second transmitting module 224 is configured to transmit a second sensing-by-proxy termination frame to the sensing-by-proxy initiator, where the second sensing-by-proxy termination frame instructs the sensing-by-proxy initiator to terminate all or part of or at least one of sensing measurements established by the sensing-by-proxy responder on behalf of the sensing-by-proxy initiator.

FIG. 32 shows a schematic structural diagram of a communication device (a station or an AP or a WLAN device or a sensing-by-proxy initiator or a sensing-by-proxy responder) according to some exemplary embodiments of the present disclosure. The communication device includes: a processor 101, a receiver 102, a transmitter 103, a memory 104, and a bus 105.

The processor 101 includes one or more processing cores, and the processor 101 performs various functional applications and information processing by running software programs and modules.

The receiver 102 and the transmitter 103 are practiced as a communication assembly. The communication assembly may be a communication chip and is also referred to as a transceiver.

The memory 104 is connected to the processor 101 through the bus 105.

The memory 104 is configured to store at least one instruction, and the processor 101 is configured to execute the at least one instruction to perform the steps in the above method embodiments.

In addition, the memory 104 is practiced by any type or combination of volatile or non-volatile storage devices including, but not limited to: magnetic or optical disks, electrically-erasable programmable read-only memories (EEPROMs), erasable programmable read-only memories (EPROMs), static random access memories (SRAMs), read-only memories (ROMs), magnetic memories, flash memories, and programmable read-only memories (PROMs).

The processor and the transceiver in the communication device involved in the embodiments of the present disclosure perform the steps applicable to the sensing-by-proxy initiator or the sensing-by-proxy responder in the methods shown in the foregoing embodiments, which are not repeated herein.

In some exemplary embodiments, a non-transitory computer-readable storage medium is further provided. The non-transitory computer-readable storage medium stores at least one instruction, at least one program, a code set, or an instruction set therein. The at least one instruction, the at least one program, the code set, or the instruction set, when loaded and executed by a processor, causes the processor to perform the method for reporting the sensing result applicable to the communication device according to the above method embodiments.

In some exemplary embodiments, a chip is further provided. The chip includes one or more programmable logic circuits and/or one or more program instructions. The chip, when running on a computer device, is caused to perform the method for reporting the sensing result according to the above embodiments.

In some exemplary embodiments, a computer program product is further provided. The computer program product, when running on a processor of a computer device, causes the computer device to perform the method for reporting the sensing result according to the above embodiments.

It will be appreciated by those of ordinary skill in the art that all or a part of the steps for implementing the above embodiments are completed by hardware, or are completed by instructing relevant hardware by a program stored in a computer-readable storage medium. The storage medium mentioned above is a read-only memory, a magnetic disk, a compact disk, or the like.

Described above are merely optional embodiments of the present disclosure and are not intended to limit the present disclosure. Any modifications, equivalent substitutions, improvements, and the like, made within the spirit and principle of the present disclosure should fall within the scope of protection of the present disclosure.

1. A method for reporting a sensing result, applicable to a sensing-by-proxy initiator, the method comprising:
receiving a sensing-by-proxy report frame or a sensing-by-proxy report frame set from a sensing-by-proxy responder, wherein the sensing-by-proxy report frame or the sensing-by-proxy report frame set carries the sensing result.

2. The method according to claim 1, wherein the sensing-by-proxy report frame carries a piece of frame data, wherein the piece of frame data is a medium access control management protocol data unit (MMPDU), and the piece of frame data comprises partial data of one measurement result in the sensing result, or all data of the one measurement result, or data of at least two measurement results.

3. The method according to claim 2, wherein in a case that at least two pieces of the frame data carry data belonging to a same measurement result, the at least two pieces of the frame data belong to a same aggregate medium access control protocol data unit (A-MPDU).

4. The method according to claim 1, further comprising:
transmitting a sensing-by-proxy request frame to the sensing-by-proxy responder, wherein the sensing-by-proxy request frame carries a requested frequency of the sensing result.

5. The method according to claim 1, further comprising:
transmitting an m^{th} sensing-by-proxy report request frame to the sensing-by-proxy responder, wherein the m^{th} sensing-by-proxy report request frame carries a terminate indication, wherein the terminate indication instructs the sensing-by-proxy responder to terminate a sensing measurement upon report of frame data corresponding to an m^{th} sensing-by-proxy report frame;
transmitting a first sensing-by-proxy termination frame to the sensing-by-proxy responder, wherein the first sensing-by-proxy termination frame instructs the sensing-by-proxy responder to terminate all or part of or at least one of sensing measurements established by the sensing-by-proxy responder on behalf of the sensing-by-proxy initiator; or
receiving a second sensing-by-proxy termination frame transmitted by the sensing-by-proxy responder, wherein the second sensing-by-proxy termination frame instructs the sensing-by-proxy initiator to terminate all or part of or at least one of sensing measurements established by the sensing-by-proxy responder on behalf of the sensing-by-proxy initiator.

6. The method according to claim 1, wherein the sensing-by-proxy report frame carries a More Cached Report indicating bit, wherein the more cached report indicating bit indicates whether more cached measurement result data needs to be transmitted upon transmission of frame data in an element.

7. The method according to claim 1, wherein the sensing-by-proxy report frame carries a report index, wherein the report index indicates a corresponding index of frame data in an element in a cache of the sensing-by-proxy responder.

8. A sensing-by-proxy initiator, comprising:
a processor and a memory storing at least one program, which when executed by the processor, causes the sensing-by-proxy initiator to:
receive a sensing-by-proxy report frame or a sensing-by-proxy report frame set from a sensing-by-proxy responder, wherein the sensing-by-proxy report frame or the sensing-by-proxy report frame set carries a sensing result.

9. The sensing-by-proxy initiator according to claim 8, wherein the sensing-by-proxy report frame carries a piece of frame data, wherein the piece of frame data is a medium access control management protocol data unit (MMPDU), and the piece of frame data comprises partial data of one measurement result in the sensing result, or all data of the one measurement result, or data of at least two measurement results.

10. The sensing-by-proxy initiator according to claim 9, wherein in a case that at least two pieces of the frame data carry data belonging to a same measurement result, the at least two pieces of the frame data belong to a same aggregate medium access control protocol data unit (A-MPDU).

11. The sensing-by-proxy initiator according to claim 8, wherein the at least one program, which when executed by the processor, causes the sensing-by-proxy initiator to:
transmit a sensing-by-proxy request frame to the sensing-by-proxy responder, wherein the sensing-by-proxy request frame carries a requested frequency of the sensing result.

12. The sensing-by-proxy initiator according to claim 8, wherein the at least one program, which when executed by the processor, causes the sensing-by-proxy initiator to:
transmit an m^{th} sensing-by-proxy report request frame to the sensing-by-proxy responder, wherein the m^{th} sensing-by-proxy report request frame carries a terminate indication, wherein the terminate indication instructs the sensing-by-proxy responder to terminate a sensing measurement upon report of frame data corresponding to an m^{th} sensing-by-proxy report frame;
transmit a first sensing-by-proxy termination frame to the sensing-by-proxy responder, wherein the first sensing-by-proxy termination frame instructs the sensing-by-proxy responder to terminate all or part of or at least one of sensing measurements established by the sensing-by-proxy responder on behalf of the sensing-by-proxy initiator; or
receive a second sensing-by-proxy termination frame transmitted by the sensing-by-proxy responder, wherein the second sensing-by-proxy termination frame instructs the sensing-by-proxy initiator to terminate all or part of or at least one of sensing measurements established by the sensing-by-proxy responder on behalf of the sensing-by-proxy initiator.

13. The sensing-by-proxy initiator according to claim 8, wherein the sensing-by-proxy report frame carries a more cached report indicating bit, wherein the more cached report indicating bit indicates whether more cached measurement result data needs to be transmitted upon transmission of frame data in an element.

14. The sensing-by-proxy initiator according to claim 8, wherein the sensing-by-proxy report frame carries a report index, wherein the report index indicates a corresponding index of frame data in an element in a cache of the sensing-by-proxy responder.

15. A sensing-by-proxy responder, comprising:
a processor and a memory storing at least one program, which when executed by the processor, causes the sensing-by-proxy responder to:
transmit a sensing-by-proxy report frame or a sensing-by-proxy report frame set to a sensing-by-proxy initiator, wherein the sensing-by-proxy report frame or the sensing-by-proxy report frame set carries a sensing result.

16. The sensing-by-proxy responder according to claim 15, wherein the sensing-by-proxy report frame carries a piece of frame data, wherein the piece of frame data is a medium access control management protocol data unit (MMPDU), and the piece of frame data comprises partial data of one measurement result in the sensing result, or all data of the one measurement result, or data of at least two measurement results.

17. The sensing-by-proxy responder according to claim 15, wherein the at least one program, which when executed by the processor, further causes the sensing-by-proxy responder to:
receive a sensing-by-proxy request frame from the sensing-by-proxy initiator, wherein the sensing-by-proxy request frame carries a requested frequency of the sensing result.

18. The sensing-by-proxy responder according to claim 15, wherein the at least one program, which when executed by the processor, further causes the sensing-by-proxy responder to:
receive an m^{th} sensing-by-proxy report request frame from the sensing-by-proxy initiator, wherein the m^{th} sensing-by-proxy report request frame carries a termination indication, wherein the termination indication instructs the sensing-by-proxy responder to terminate a sensing measurement upon report of frame data corresponding to an m^{th} sensing-by-proxy report frame; or
receive a first sensing-by-proxy termination frame from the sensing-by-proxy initiator, wherein the first sensing-by-proxy termination frame instructs the sensing-by-proxy responder to terminate all or part of or at least one of sensing measurements established by the sensing-by-proxy responder on behalf of the sensing-by-proxy initiator; or
transmit a second sensing-by-proxy termination frame to the sensing-by-proxy initiator, wherein the second sensing-by-proxy termination frame instructs the sensing-by-proxy initiator to terminate all or part of or at least one of sensing measurements established by the sensing-by-proxy responder on behalf of the sensing-by-proxy initiator.

19. The sensing-by-proxy responder according to claim 15, wherein the sensing-by-proxy report frame carries a More Cached Report indicating bit, wherein the more cached report indicating bit indicates whether more cached measurement result data needs to be transmitted upon transmission of frame data in an element.

20. The sensing-by-proxy responder according to claim 15, wherein the sensing-by-proxy report frame carries a report index, wherein the report index indicates a corresponding index of frame data in an element in a cache of the sensing-by-proxy responder.
